(19) United States
(12) Patent Application Publication
(10) Pub. No.: US 2025/0126671 A1
(43) Pub. Date: Apr. 17, 2025

(54) WIRELESS RANGE EXTENSION FOR COMMUNICATIONS IN A WIRELESS COMMUNICATION NETWORK

(71) Applicant: QUALCOMM INCORPORATED, San Diego, CA (US)

(72) Inventors: Yangjun ZHANG, Shanghai (CN); Kapil RAI, Sunnyvale, CA (US); Sandip HOMCHAUDHURI, San Jose, CA (US); Lin YANG, Shanghai (CN); Yusheng YANG, Shanghai (CN); Alireza RAISSINIA, Monte Sereno, CA (US)

(21) Appl. No.: 18/834,198

(22) PCT Filed: Mar. 7, 2022
(86) PCT No.: PCT/CN2022/079479

§ 371 Date: Jul. 29, 2024

(51) Int. Cl. H04W 76/20; H04W 74/00; H04W 74/0816; H04W 84/12

(52) U.S. Cl. CPC H04W 76/20; H04W 74/002; H04W 74/0816; H04W 84/12

(57) ABSTRACT

This disclosure provides systems, methods, and apparatus, including computer programs encoded on computer-readable media, for wireless range extension for communication in a wireless local area network (WLAN). In some aspects, a first WLAN device and a second WLAN device may exchange one or more management frames advertising support for a non-orthogonal frequency-division multiplexing (non-OFDM) data rate for communications via one or more non-2.4 GHz bands. In some aspects, the non-OFDM data rate may be a data rate of a plurality of data rates associated with an IEEE 802.11b standard, and the one or more non-2.4 GHz bands may include one or more of a 3.5 GHz band, a 5 GHz band, a 6 GHz band, a 45 GHz band, and a 60 GHz band. The first and second WLAN devices may select the non-OFDM data rate and at least one of the non-2.4 GHz bands for exchange data communications.

### CROSS REFERENCE

The present Application is a 371 national stage filing of International PCT Application No. PCT/CN2022/079479 by ZHANG et al. entitled “WIRELESS RANGE EXTENSION FOR COMMUNICATIONS IN A WIRELESS COMMUNICATION NETWORK,” filed Mar. 7, 2022, which is assigned to the assignee hereof, and which is expressly incorporated by reference in its entirety herein.

### TECHNICAL FIELD

This disclosure generally relates to the field of wireless communication, and more particularly, to wireless range extension for communications in a wireless communication network.

### DESCRIPTION OF THE RELATED TECHNOLOGY

A wireless local area network (WLAN) in an infrastructure mode may be formed by two or more WLAN devices (which may be referred to as stations (STAs)) that share a wireless communication medium using common service settings. One or more of the WLAN devices (which may be referred to as an access point (AP)) may establish the common service settings. An AP is a type of STA that performs a distribution system access function in the WLAN. The basic building block of a WLAN conforming to the Institute of Electrical and Electronics Engineers (IEEE) 802.11 family of standards is a basic service set (BSS), which is managed by an AP. An AP is a type of WLAN device that performs a distribution system access function in the WLAN. Each BSS is identified by a BSS identifier (BSSID) that is advertised by the AP. An AP periodically broadcasts beacon frames to enable any STAs within wireless range of the AP to establish or maintain a communication link with the WLAN.

STAs also may form networks without APs or other equipment other than the STAs themselves. One example of such a network is an ad hoc network. Ad hoc networks may alternatively be referred to as independent basic service set (IBSS) networks defined in IEEE 802.11 or mesh networks or peer-to-peer (P2P) networks. In some cases, ad hoc networks may be implemented within a WLAN. While the STAs may be capable of communicating with each other through an AP, STAs in an ad hoc network also can communicate directly with each other via direct wireless links.

### SUMMARY

The systems, methods, and devices of this disclosure each have several innovative aspects, no single one of which is solely responsible for the desirable attributes disclosed herein.

One innovative aspect of the subject matter described in this disclosure can be implemented by a method for wireless communication performed by an apparatus of a first wireless local area network (WLAN) device. The method may include receiving one or more management frames including a first management frame from a second WLAN device. The first management frame may indicate the second WLAN device supports a non-orthogonal frequency-division multiplexing (non-OFDM) data rate for communications via one or more frequency bands. The one or more frequency bands may include one or more non-2.4 GHz bands. The method may include transmitting a second management frame to the second WLAN device. The second management frame may indicate the first WLAN device supports the non-OFDM data rate for communications via the one or more frequency bands.

In some implementations, the non-OFDM data rate may be a data rate of a plurality of data rates associated with an IEEE 802.11b standard, and the one or more non-2.4 GHz bands may include one or more of a 3.5 GHz band, a 5 GHz band, a 6 GHz band, a 45 GHz band, and a 60 GHz band.

In some implementations, the non-OFDM data rate may be a data rate of a plurality of non-conformant data rates, and the one or more non-2.4 GHz bands may include one or more of a 3.5 GHz band, a 5 GHz band, a 6 GHz band, a 45 GHz band, and a 60 GHz band.

In some implementations, the method may include receiving a third management frame indicating the second WLAN device supports an OFDM data rate for communications via the one or more frequency bands, and selecting either the non-OFDM data rate associated with the first management frame or the OFDM data rate associated with the third management frame for communications via the one or more frequency bands.

In some implementations, the method may include receiving the first management frame via a first BSS associated with the non-OFDM data rate. The first management frame may indicate the second WLAN device supports the non-OFDM data rate for communications via the one or more frequency bands. The method may include receiving a third management frame via a second BSS associated with an OFDM data rate. The third management frame may indicate the second WLAN device supports an OFDM data rate for communications via the one or more frequency bands. The method may include selecting either the first BSS associated with the non-OFDM data rate and the first management frame or the second BSS associated with the OFDM data rate and the third management frame.

Another innovative aspect of the subject matter described in this disclosure can be implemented by a method for wireless communication performed by an apparatus of a second WLAN device. The method may include selecting a non-OFDM data rate for one or more frequency bands. The selection of the non-OFDM data rate associated with a link quality of a communication link between the second WLAN device and a first WLAN device. The method may include transmitting one or more management frames including a first management frame to the first WLAN device. The first management frame may indicate the second WLAN device supports the non-OFDM data rate for communications via the one or more frequency bands. The method may include receiving a second management frame from the first WLAN device. The second management frame may indicate the first WLAN device supports the non-OFDM data rate for communications via the one or more frequency bands.

In some implementations, the method may include transmitting a third management frame to the first WLAN device. The third management frame may indicate the second WLAN device supports an OFDM data rate for communications via the one or more frequency bands.

In some implementations, the method may include transmitting the first management frame to the first WLAN device via a first BSS associated with the non-OFDM data rate. The first management frame may indicate the second WLAN device supports the non-OFDM data rate for communications via the one or more frequency bands. The method may include transmitting a third management frame to the first WLAN device via a second BSS associated with an OFDM data rate. The third management frame indicating the second WLAN device supports an OFDM data rate for communications via the one or more frequency bands.

Another aspect of the subject matter described in this disclosure can be implemented in an apparatus of a first WLAN device. The apparatus may include one or more processors and one or more interfaces. The one or more interfaces may be configured to receive one or more management frames including a first management frame from a second WLAN device. The first management frame may indicate the second WLAN device supports a non-OFDM data rate for communications via one or more frequency bands. The one or more frequency bands may include one or more non-2.4 GHzb bands. The one or more interfaces may be configured to transmit a second management frame to the second WLAN device. The second management frame may indicate the first WLAN device supports the non-OFDM data rate for communications via the one or more frequency bands.

Another aspect of the subject matter described in this disclosure can be implemented in an apparatus of a second WLAN device. The apparatus may include one or more processors and one or more interfaces. The one or more processors may be configured to select a non-OFDM data rate for one or more frequency bands. The selection of the non-OFDM data rate may be associated with a link quality of a communication link between the second WLAN device and a first WLAN device. The one or more interfaces may be configured to transmit one or more management frames including a first management frame to the first WLAN device. The first management frame may indicate the second WLAN device supports the non-OFDM data rate for communications via the one or more frequency bands. The one or more interfaces may be configured to receive a second management frame from the first WLAN device. The second management frame may indicate the first WLAN device supports the non-OFDM data rate for communications via the one or more frequency bands.

Aspects of the subject matter described in this disclosure can be implemented in a device, a software program, a system, or other means to perform any of the above-mentioned methods.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows a system diagram of an example wireless communication network.

FIG. 2 shows a system diagram of an example wireless local always network (WLAN) including WLAN devices configured to implement range extension for wireless communications.

FIG. 3 shows an example message flow diagram that shows an exchange of management frames between a first WLAN device and a second WLAN device that advertise support for 802.11b data rates in one or more non-2.4 GHz bands, such as one or more of the 3.5 GHz, 5 GHz, 6 GHz, 45 GHz, and 60 GHz bands.

FIG. 4 shows an example conceptual beacon frame diagrams that show beacon frames that may be transmitted by the second WLAN device for one-to-N communications.

FIG. 5 shows a flowchart with example operations performed by an apparatus of a WLAN device for implementing a data rate control mechanism.

FIG. 6 shows an example message flow diagram that shows the transmission of control frames by a first WLAN device and a second WLAN device to implement a protection mechanism for reducing interference from neighboring WLAN devices and improving coexistence.

FIG. 7 shows another example conceptual diagram that shows the transmission of control frames by a first WLAN device and a second WLAN device to implement a protection mechanism for reducing interference from neighboring WLAN devices and improving coexistence.

FIG. 8 depicts a flowchart with example operations performed by an apparatus of a first WLAN device to implement range extension for one or more non-2.4 GHz bands.

FIG. 9 depicts a flowchart with example operations performed by an apparatus of a second WLAN device to implement range extension for one or more non-2.4 GHz bands.

FIG. 10 shows a block diagram of an example wireless communication device.

FIG. 11A shows a block diagram of an example AP.

FIG. 11B shows a block diagram of an example STA.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. The examples in this disclosure are based on wireless local area network (WLAN) communication according to the Institute of Electrical and Electronics Engineers (IEEE) 802.11 wireless standards. However, the described implementations may be implemented in any device, system or network that is capable of transmitting and receiving radio frequency (RF) signals according to one or more of the IEEE 802.11 standards, the Bluetooth® standard, code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless, cellular or internet of things (IoT) network, such as a system utilizing 3G, 4G, 5G, 6G, or further implementations thereof, technology.

In wireless communication networks, the data rates associated with the IEEE 802.11b standard (which may be referred to as 802.11b data rates) are typically used for communications in the 2.4 GHz band. Typically, 802.11b data rates are used for long range communications in the 2.4 GHz band. However, the 2.4 GHz band is typically very congested. The data rates that are typically used when implementing orthogonal frequency division multiplexing (OFDM), which may be referred to as OFDM data rates and are defined in the IEEE 802.11 standard, are typically used for communications in non-2.4 GHz frequency bands, such as the 5 GHz and 6 GHz bands. The OFDM data rates are typically used for short range communications in the 5 GHz and 6 GHz bands. The 5 GHz and 6 GHz bands are typically not as congested as the 2.4 GHz band. As described further herein, short range communications may include communications that are within the range of OFDM data rates, and long range communications may include communications that are outside the range of OFDM data rates (and within the range of 802.11b data rates).

In some implementations, WLAN devices may implement the 802.11b data rates in one or more non-2.4 GHz bands, such as one or more of the 3.5 GHz, 5 GHz, 6 GHz, 45 GHz, and 60 GHz bands, in order to utilize the long range communication capabilities of the 802.11b data rates in frequency bands that are less congested. The 802.11b data rates may be referred to as non-OFDM data rates. In some implementations, the non-OFDM data rates also may include various non-conformant data rates in one or more non-2.4 GHz bands, such as one or more of the 3.5 GHz, 5 GHz, 6 GHz, 45 GHz, and 60 GHz bands. The 802.11b data rates may include 802.11b wideband rates or 802.11b narrow band rates. The 802.11b wideband rates may be referred to as non-OFDM wideband rates, and the 80211b narrow band rates may be referred to as non-OFDM narrow band rates. The 802.11b narrow band rates (or the non-OFDM narrow band rates) may include quarter rates or half rates. The WLAN devices may be devices operating in an infrastructure mode, an ad hoc mode, a peer-to-peer (P2P) mode, a Bluetooth over IP (BToIP) mode, or a Neighbor Awareness Networking (NAN) mode, to name a few examples.

In some implementations, a first WLAN device and a second WLAN device may advertise their support for the 802.11b data rates (also referred to as non-OFDM data rates) in the one or more non-2.4 GHz bands, such as one or more of the 3.5 GHz, 5 GHz, 6 GHz, 45 GHz, and 60 GHz bands. The first WLAN device and the second WLAN device may exchange management frames to indicate support for the 802.11b data rates in the one or more non-2.4 GHz bands. The management frames may include beacon frames, probe response frames, probe request frames, association request frames, an association response frames, a reassociation request frame, a reassociation response frame, proprietary frames, and vendor-defined frames. In some implementations, the management frames may indicate support for the 802.11b data rates in the one or more non-2.4 GHz bands using one or more new bits, one or more new fields, or one or more existing fields in an existing information element (IE) (or existing vendor IE), a new IE (or new vendor IE), or other types of frame IEs or elements.

In some implementations, for one-to-one communications between WLAN devices, a WLAN device may adjust the data rate that is used for the transmission of beacon frames (and other communications) based on the link quality of a communication link between the WLAN devices. The link quality of the communication link may vary based on the distance between the WLAN devices. The link quality may be determined or ascertained by measuring the receive signal strength indicator (RSSI) associated with the communication link, or the packet error rate (PER) associated with the communication link, or both.

In some implementations, for one-to-N communications between WLAN devices, a WLAN device may transmit two or more beacon frames during a beacon interval. Each beacon frame may indicate support for a different data rate. For example, a source or transmitting WLAN device may transmit a first beacon frame that indicates support for an OFDM data rate and a second beacon frame that indicates support for an 802.11b data rate (or a non-OFDM data rate). A destination or receiving WLAN device may receive the first and second beacon frames and select one of the beacon frames to follow or adopt for subsequent communications depending on the data rate capabilities of the destination WLAN device.

In some implementations, for one-to-N communications between WLAN devices, a source or transmitting WLAN device may create two or more BSSs having two or more corresponding SSIDs. The source WLAN device may transmit two or more beacon frames via the corresponding two or more BSSs, with each beacon frame indicating support for a different data rate. For example, when the source WLAN device utilizes two BSSs, the source WLAN device may transmit a first beacon frame that indicates support for an OFDM data rate via a first BSS having a first SSID, and a second beacon frame that indicates support for a non-OFDM data rate (or an 802.11b data rate) via a second BSS having a second SSID. The destination or receiving WLAN device may receive the first beacon frame via the first BSS and the second beacon frame via the second BSS, and may select or otherwise determine which beacon frame to follow or adopt for subsequent communications depending on its data rate capabilities.

In some implementations, the WLAN devices may implement a four (4)-way protection mechanism using control frames for reducing interference from neighboring WLAN devices. The control frames may include clear to send (CTS) frames, request to send (RTS) frames, and CTS-to-Self (CTS2Self) frames. In some implementations, the WLAN devices may implement a beacon frame protection mechanism using control frames for reducing interference from neighboring WLAN devices.

Particular implementations of the subject matter described in this disclosure can be implemented to realize one or more of the following potential advantages. Implementing 802.11b data rates in one or more non-2.4GHz bands, such as the 5 GHz and 6 GHz bands, may utilize the long range communication capabilities of the 802.11b data rates in frequency bands that are less congested. The rate control mechanism may allow the WLAN devices to adjust the data rate that is used for communications (between OFDM data rates, 802.11b wideband rates, and 802.11b narrow band rates) based on a link quality associated with the communication link. Implementing two or more beacon frames having two or more different data rates in a single BSS or in two or more BSSs may allow a WLAN device to select, follow or adopt one of the beacon frames depending on the data rate capabilities of the WLAN device. An interference protection mechanism that utilizes control frames may eliminate or reduce interference from neighboring WLAN devices when utilizing 802.11b data rates. Utilizing 802.11b data rates in one or more non-2.4 GHz bands, implementing a rate control mechanism, implementing dual beacon frames, and implementing an interference protection mechanism may expand the range of operation of WLAN devices and may improve the performance of the WLAN devices and the wireless communication network, and thereby may improve the overall user experience.

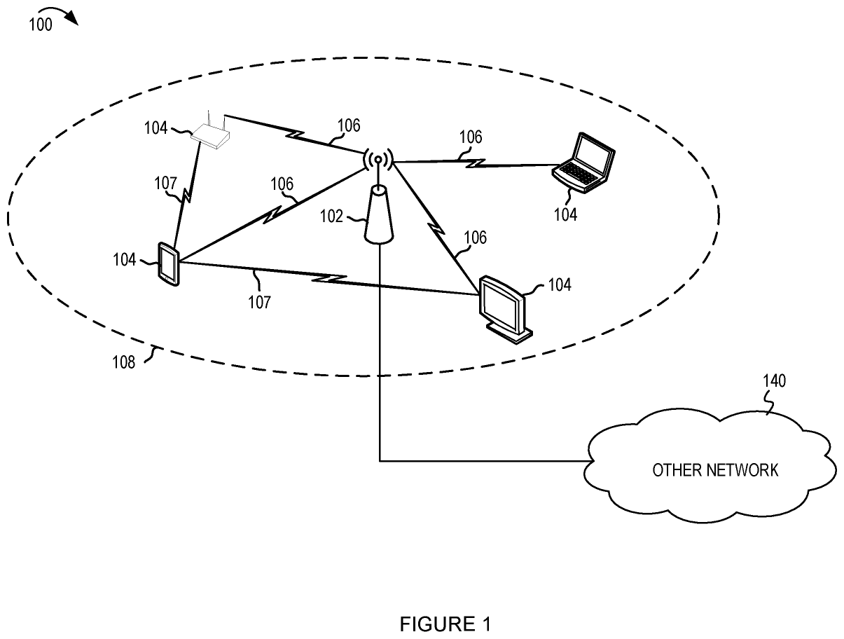

FIG. 1 shows a system diagram of an example wireless communication network 100. According to some aspects, the wireless communication network 100 can be an example of a wireless local area network (WLAN) such as a Wi-Fi network (and will hereinafter be referred to as WLAN 100). For example, the WLAN 100 can be a network implementing at least one of the IEEE 802.11 family of standards (such as that defined by the IEEE 802.11-2016 specification or amendments thereof including, but not limited to, 802.11a, 802.11b, 802.11aa, 802.11ac, 802.11ah, 802.11ad, 802.11aq, 802.11ay, 802.11ax, 802.11az, 802.11ba and 802.11be). The WLAN 100 may include numerous WLAN devices (which also may be referred to as wireless communication devices) such as an access point (AP) 102 and multiple stations (STAs) 104 that have a wireless association with the AP 102. While only one AP 102 is shown, the WLAN network 100 also can include multiple APs 102. The IEEE 802.11-2016 standard defines a STA as an addressable unit. An AP is an entity that contains at least one STA and provides access via a wireless medium (WM) for associated STAs to access a distribution service (such as another network, not shown). Thus, an AP includes a STA and a distribution system access function (DSAF). In the example of FIG. 1, the AP 102 may be connected to a gateway device (not shown) which provides connectivity to the other network 140. The DSAF of the AP 102 may provide access between the STAs 104 and another network 140. While AP 102 is described as an access point using an infrastructure mode, in some implementations, the AP 102 may be a traditional STA which is operating as an AP. For example, the AP 102 may be a STA capable of operating in a peer-to-peer mode or independent mode. In some other examples, the AP 102 may be a software AP (SoftAP) operating on a computer system.

Each of the STAs 104 also may be referred to as a mobile station (MS), a mobile device, a mobile handset, a wireless handset, an access terminal (AT), a user equipment (UE), a subscriber station (SS), or a subscriber unit, among other possibilities. The STAs 104 may represent various devices such as mobile phones, personal digital assistant (PDAs), other handheld devices, netbooks, notebook computers, tablet computers, laptops, display devices (for example, TVs, computer monitors, navigation systems, among others), music or other audio or stereo devices, remote control devices (“remotes”), printers, kitchen or other household appliances, key fobs (for example, for passive keyless entry and start (PKES) systems), among other possibilities.

A single AP 102 and an associated set of STAs 104 may be referred to as a basic service set (BSS), which is managed by the respective AP 102. FIG. 1 additionally shows an example coverage area 108 of the AP 102, which may represent a basic service area (BSA) of the WLAN 100. The BSS may be identified to users by a service set identifier (SSID), as well as to other devices by a basic service set identifier (BSSID), which may be a media access control (MAC) address of the AP 102. The AP 102 periodically broadcasts beacon frames (“beacons”) including the BSSID to enable any STAs 104 within wireless range of the AP 102 to establish a respective communication link 106 (hereinafter also referred to as a “Wi-Fi link”), or to maintain a communication link 106, with the AP 102. For example, the beacons can include an identification of a primary channel used by the respective AP 102 as well as a timing synchronization function for establishing or maintaining timing synchronization with the AP. The AP 102 may provide access to external networks (such as the network 140) to various STAs 104 in the WLAN via respective communication links 106. To establish a communication link 106 with an AP 102, each of the STAs 104 is configured to perform passive or active scanning operations (“scans”) on frequency channels in one or more frequency bands (for example, the 2.4 GHz, 5 GHz, 6 GHz or 60 GHz bands). To perform passive scanning, a STA 104 listens for beacons, which are transmitted by respective APs 102 at a periodic time interval referred to as the target beacon transmission time (TBTT) (measured in time units (TUs) where one TU may be equal to 1024 microseconds (μs)). To perform active scanning, a STA 104 generates and sequentially transmits probe requests on each channel to be scanned and listens for probe responses from APs 102. Each STA 104 may be configured to identify or select an AP 102 with which to associate based on the scanning information obtained through the passive or active scans, and to perform authentication and association operations to establish a communication link 106 with the selected AP 102. The AP 102 may assign an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA or to select among multiple APs 102 that together form an extended service set (ESS) including multiple connected BSSs. An extended network station associated with the WLAN 100 may be connected to a wired or wireless distribution system that may allow multiple APs 102 to be connected in such an ESS. As such, a STA 104 can be covered by more than one AP 102 and can associate with different APs 102 at different times for different transmissions. Additionally, after association with an AP 102, a STA 104 also may be configured to periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some cases, STAs 104 may form networks without APs 102 or other equipment other than the STAs 104 themselves. One example of such a network is an ad hoc network (or wireless ad hoc network). Ad hoc networks may alternatively be referred to as independent basic service set (IBSS) networks or mesh networks or peer-to-peer (P2P) networks. In some cases, ad hoc networks may be implemented within a larger wireless network such as the WLAN 100. In such implementations, while the STAs 104 may be capable of communicating with each other through the AP 102 using communication links 106, STAs 104 also can communicate directly with each other via direct wireless links 107. Additionally, two STAs 104 may communicate via a direct wireless link 107 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless links 107 include Wi-Fi Direct connections, connections established by using a Wi-Fi Tunneled Direct Link Setup (TDLS) link, and other P2P group connections. Another example of such a network is a neighbor awareness network (NAN). NANs operate in accordance with the Wi-Fi Alliance (WFA) Neighbor Awareness Networking (also referred to as NAN) standard specification. NAN-compliant STAs (which may be referred to as wireless communication devices, WLAN devices, or NAN devices) transmit and receive packets including frames conforming to an IEEE 802.11 wireless communication protocol standard to and from one another via direct wireless links (such as the direct wireless links 107). The direct wireless links 107 also may be referred to as wireless P2P links.

The APs 102 and STAs 104 may function and communicate (via the respective communication links 106) according to the IEEE 802.11 family of standards (such as that defined by the IEEE 802.11-2016 specification or amendments thereof including, but not limited to, 802.11a, 802.11b, 802.11aa, 802.11ah, 802.11aq, 802.11ad, 802.11ay, 802.11ax, 802.11az, 802.11ba and 802.11be). These standards define the WLAN radio and baseband protocols for the PHY and medium access control (MAC) layers. The APs 102 and STAs 104 transmit and receive wireless communications (hereinafter also referred to as “Wi-Fi communications”) to and from one another in the form of physical layer convergence protocol (PLCP) protocol data units (PPDUs).

Each of the frequency bands may include multiple sub-bands or frequency channels. For example, PPDUs conforming to the IEEE 802.11n, 802.11ac, 802.11ax and 802.11be standard amendments may be transmitted over the 2.4 and 5 GHz bands, each of which is divided into multiple 20 MHz channels. As such, these PPDUs are transmitted over a physical channel having a minimum bandwidth of 20 MHz, but larger channels can be formed through channel bonding. For example, PPDUs conforming to the IEEE 802.11n, 802.11ac. 802.11ax, and 802.11be standard amendments may be transmitted over physical channels having bandwidths of 40 MHz, 80 MHz, 80+80 MHz, 160 MHz, 160+160 MHz or 320 MHz by bonding together two or more 20 MHz channels, which can be contiguously allocated or non-contiguously allocated. For example, IEEE 802.11n describes the use of up to 2 channels (for a combined 40 MHz bandwidth) and defined a High Throughput (HT) transmission format. IEEE 802.11ac describes the use of up to 8 channels (for a maximum combined 160 MHz bandwidth) and defined a Very High Throughput (VHT) transmission format. IEEE 802.11ax also supports up to a combined 160 MHz bandwidth (which may be a combination of up to 8 channels of 20 MHz width each). IEEE 802.11be may support up to a combined 320 MHz bandwidth (which may be a combination of up to 16 channels of 20 MHz width each).

The APs 102 and STAs 104 in the WLAN 100 may transmit PPDUs over an unlicensed spectrum, which may be a portion of spectrum that includes frequency bands traditionally used by Wi-Fi technology, such as the 2.4 GHz band, the 5 GHz band, the 60 GHz band, and the 900 MHz band. Some implementations of the APs 102 and STAs 104 described herein also may communicate in other frequency bands, such as the 6 GHz band, which may support both licensed and unlicensed communications. The APs 102 and STAs 104 also can be configured to communicate over other frequency bands such as shared licensed frequency bands, where multiple operators may have a license to operate in the same or overlapping frequency band or bands.

Each PPDU is a composite structure that includes a PHY preamble, a PHY header, and a payload in the form of a PLCP service data unit (PSDU). For example, the PSDU may include the PHY preamble and header (which may be referred to as PLCP preamble and header) as well as one or more MAC protocol data units (MPDUs). The information provided in the PHY preamble and header may be used by a receiving device to decode the subsequent data in the PSDU. In instances in which PPDUs are transmitted over a bonded channel, the preamble and header fields may be duplicated and transmitted in each of the multiple component channels. The PHY preamble may be used for packet detection, automatic gain control and channel estimation, among other uses. The format of, coding of, and information provided in the PHY header is based on the particular IEEE 802.11 protocol to be used to transmit the payload, and typically includes signaling fields (such as SIG-A and SIG-B fields) that include BSS and addressing information, such as a BSS color and a STA ID.

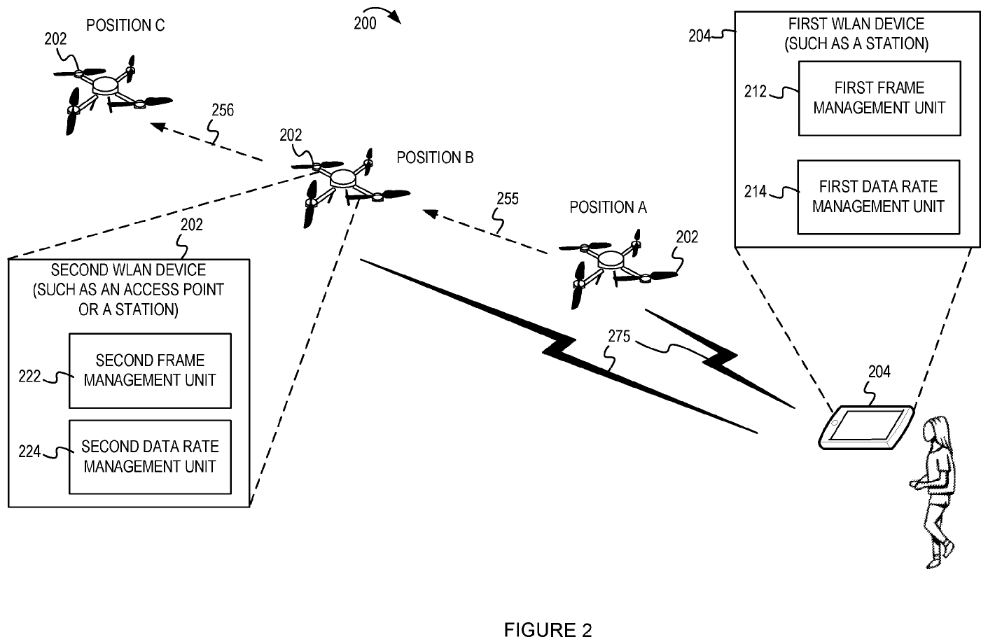

FIG. 2 shows a system diagram of an example WLAN 200 including WLAN devices configured to implement range extension for wireless communications. The WLAN 200 shown in FIG. 2 may be based on the example WLAN 100 described in FIG. 1. The WLAN 200 may include a first WLAN device 204 and second WLAN device 202. In some implementations, the first WLAN device 204 and the second WLAN device 202 may be a station (STA) and an access point (AP) operating in an infrastructure mode. For example, the first WLAN device 204 may be an example implementation of the STAs 104 of FIG. 1, and the second WLAN device 202 may be an example implementation of the AP 102 of FIG. 1. In some implementations, the first WLAN device 204 and the second WLAN device 202 may be STAs in an ad hoc mode, a peer-to-peer (P2P) mode, a Bluetooth over IP (BToIP) mode, or Neighbor Awareness Networking (NAN) mode, to name but a few examples. For example, each of the first WLAN device 204 and the second WLAN device 202 may be an example implementation of one or more of the STAs 104 of FIG. 1 that communicate via direct wireless links (which also may be referred as wireless P2P links), such as the direct wireless links 107 shown in FIG. 1. Furthermore, although not shown for simplicity. the WLAN 200 may include one or more additional WLAN devices.

In some implementations, the first WLAN device 204 may include a first frame management unit 212 and a first data rate management unit 214, and the second WLAN device 202 may include a second frame management unit 222 and a second data rate management unit 224. The first frame management unit 212 and the second frame management unit 222 may transmit management frames to advertise support for 802.11b data rates in one or more non-2.4 GHz bands, such as the 5 GHz, 6 GHz, 45 GHz, and 60 GHz bands. The second frame management unit 222 also may transmit two or more beacon frames utilizing two or more different data rates in a single BSS or two or more BSSs, which may allow the first frame management unit 212 and the first data rate management unit 214 to select, follow or adopt one of the beacon frames depending on the data rate capabilities of the first WLAN device 204. The first frame management unit 212 and the second frame management unit 222 also may transmit control frames to implement an interference protection mechanism for reducing interference from neighboring WLAN devices. The second data rate management unit 224 may implement a data rate control mechanism that may select either an OFDM data rate or an 802.11b data rate (or non-OFDM data rate) for communications depending on a link quality of the communication link.

In some implementations, the first WLAN device 204 and the second WLAN device 202 may implement data rates associated with the IEEE 802.11b standard in frequency bands outside of the 2.4 GHz band (which may be referred to as non-2.4 GHz bands), such as the 3.5 GHz, 5 GHz, 6 GHz, 45 GHz, and 60 GHz bands. The data rates associated with the IEEE 802.11b standard may be referred to as non-OFDM data rates or 802.11b data rates. The data rates associated with the IEEE 802.11b standard are typically used for communications in the 2.4 GHz band and have long range capabilities. However, the 2.4 GHz band is typically very congested. The data rates that are typically used for communications in the non-2.4 GHz bands, such as the 5 GHz and 6 GHz bands, may be referred to as OFDM data rates. The 5 GHz and 6 GHz bands are typically less congested, but the OFDM data rates typically have short range capabilities. In some implementations, the first WLAN device 204 and the second WLAN device 202 may implement the 802.11b data rates (or the non-OFDM data rates) in the non-2.4 GHz frequency bands, such as the 5 GHz and 6 GHz bands, in order to utilize the long range capabilities of the 802.11b data rates in frequency bands that are less congested. Since the 802.11b data rates may be implemented in frequency bands (such as non-2.4 GHz bands) that the 802.11b data rates are typically not used, the 802.11b data rates also may be referred to as non-conformant data rates. The 802.11b data rates may include 802.11b wideband rates or 802.11b narrow band rates. The 802.11b narrow band rates may include quarter rates or half rates. For example, when the first WLAN device 204 is a drone controller operating as a STA and the second WLAN device 202 is a drone operating as an AP, the drone controller and the drone may use 802.11b data rates (either 802.11b wideband or narrow band rates) for a stable exchange of control and status information over long distances (such as several kilometers) via an uncongested channel in either the 5 GHz band or the 6 GHz band. In the example shown in FIG. 2, when the drone shown travels (shown by dashed line 255) from position A to position B that is several kilometers from the drone controller, the drone and drone controller may use 802.11b data rates (either 802.11b wideband or narrow band rates) for communications in either the 5 GHz band or the 6 GHz band. As another example, when the first WLAN device 204 is operating as a first STA and the second WLAN device 202 is operating as a second STA that implement BToIP, the first STA and the second STA may extend the range of BToIP communications by using 802.11b data rates (either 802.11b wideband or narrow band rates) in either the 5 GHz band or the 6 GHz band. As another example, when the first WLAN device 204 is operating as a STA and the second WLAN device 202 is operating as a commercial AP, the STA and the commercial AP may use 802.11b data rates (either 802.11b wideband or narrow band rates) in either the 5 GHz band or the 6 GHz band to improve the unbalanced coverage between the commercial AP and the STA in a pre-11ax mode.

In some implementations, the first WLAN device 204 and the second WLAN device 202 may advertise their support for the 802.11b data rates (also referred to as non-OFDM data rates) in one or more non-2.4 GHz bands. As described herein, the one or more non-2.4 GHz bands may include one or more of the 3.5 GHz, 5 GHz, 6 GHz, 45 GHz, and 60 GHz bands. The 3.5 GHz, 5 GHz, 6 GHz, 45 GHz, and 60 GHz bands also may be referred to as frequency bands having frequencies that are higher than the 2.4 GHz band. In some implementations, the non-OFDM data rates also may include various non-conformant data rates in one or more non-2.4 GHz bands, such as one or more of the 3.5 GHz, 5 GHz, 6 GHz, 45 GHz, and 60 GHz bands. For example, in addition to the 802.11b data rates, one or more additional non-conformant data rates may be used in one or more non-2.4 GHz bands, such as one or more of the 3.5 GHz, 5 GHz, 6 GHz, 45 GHz, and 60 GHz bands. The first WLAN device 204 and the second WLAN device 202 may exchange management frames to indicate support for the 802.11b data rates (or non-OFDM data rates) in the non-2.4 GHz bands, such as the 5 GHz and 6 GHz bands. For example, if the second WLAN device 202 is configured as an AP, the AP may indicate support for the 802.11b data rates in the 5 GHz and 6 GHz bands via a beacon frame, a probe response frame, an association response frame, a reassociation response frame, or other management frames (such as vendor-defined frames). As another example, if the first WLAN device 204 is configured as a STA, the STA may indicate support for the 802.11b data rates in the 5 GHz and 6 GHz bands via a probe request frame, an association request frame, reassociation request frame, or other management frames (such as vendor-defined frames). As another example, the first WLAN device 204 and the second WLAN device 202 may indicate support for the 802.11b data rates in the 5 GHz and 6 GHz bands via proprietary frames. In some implementations, the management frames described herein may indicate support for the 802.11b data rates in the non-2.4 GHz bands (such as the 5 GHz and 6 GHz bands) using one or more new bits, one or more new fields, or one or more existing fields in an existing information element (IE) (or existing vendor IE), a new IE (or new vendor IE), or other types of frame IEs or elements.

In some implementations, for one-to-one communications, the second WLAN device 202 may adjust the data rate that is used for the transmission of beacon frames (and other communications) to the first WLAN device 204 based on the link quality of a communication link 275 between the WLAN devices. The link quality may be determined or ascertained by measuring the receive signal strength indicator (RSSI) associated with the communication link 275, or the packet error rate (PER) associated with the communication link 275, or both. The link quality of the communication link 275 typically varies based on the distance between the first WLAN device 204 and the second WLAN device 202. For example, when the second WLAN device 202 is at position A, the communication link 275 may have a good link quality when using OFDM data rates for short range communications (such as a distance of a few hundred meters). When the second WLAN device 202 moves (shown by the dashed arrow 255) from position A to position B, the link quality may drop for long range communications (such as a distance of one or more kilometers). In some implementations, the second WLAN device 202 may select an 802.11b data rate (or a non-OFDM data rate) for the beacon frame (and other communications) after detecting the drop in the link quality. For example, the second WLAN device 202 may change from an OFDM data rate to a non-OFDM data rate for the beacon frame after detecting a poor link quality as the distance between the second WLAN device 202 and the first WLAN device significantly increases, such as when the second WLAN device 202 moves from position A to position B. In one example, position A may be a few hundred meters and position B may be one or more kilometers. In some implementations, the second WLAN device 202 may select an 802.11b wideband rate (which also may be referred to as a non-OFDM wideband rate) when the second WLAN device 202 is at position B.

For example, an 802.11b wideband rate may be 1 Mbps or any other 802.11b wideband rate. In some implementations, when the second WLAN device 202 moves (shown by the dashed arrow 256) from position B to position C, the second WLAN device 202 may select an 802.11b narrow band rate (which also may be referred to as a non-OFDM narrow band rate) for the beacon frame (and other communications). For example, an 802.11b narrow band rate may include an 802.11b half rate or an 802.11b quarter rate (which also may be referred to as non-OFDM half or quarter rates). The second WLAN device 202 may change from a non-OFDM wideband rate to a non-OFDM narrow band rate for the beacon frame after detecting a drop in the link quality when the second WLAN device 202 moves from position B to position C. In one example, position B may be a few kilometers and position C may be tens of kilometers.

In some implementations, for one-to-N communications, the second WLAN device 202 may transmit two or more beacon frames during a beacon interval, where each beacon frame indicates support for a different data rate. For example, when the second WLAN device 202 implements dual beacon frames, the second WLAN device 202 may transmit a first beacon frame that indicates support for an OFDM data rate and a second beacon frame that indicates support for a non-OFDM data rate (or an 802.11b data rate). The first WLAN device 204 may receive the first and second beacon frames and determine or ascertain which beacon frame to select, follow or adopt for subsequent communications depending on the data rate capabilities of the first WLAN device 204. For example, if the first WLAN device 204 supports only OFDM data rates, the first WLAN device 204 may select, follow or adopt the first beacon frame indicating support for the OFDM data rate associated with the first beacon frame. If the first WLAN device 204 supports only 802.11b data rates (such as 802.11b wideband rates and narrow band rates), the first WLAN device 204 may select, follow or adopt the second beacon frame indicating support for the non-OFDM data rate associated with the second beacon frame. If the first WLAN device 204 supports both OFDM and non-OFDM data rates, the first WLAN device 204 may select, follow or adopt the second beacon frame indicating support for the 802.11b data rates. In some implementations, if all the WLAN devices (including the first WLAN device 204) connected to the second WLAN device 202 support 802.11b data rates, the second WLAN device 202 may transmit a single beacon frame during the beacon interval that indicates support for the 802.11b data rates.

In some implementations, for one-to-N communications, the second WLAN device 202 may create two or more BSSs having two or more corresponding SSIDs using a multi-SSID feature. The second WLAN device 202 may transmit two or more beacon frames via the corresponding two or more BSSs, where each beacon frame indicates support for a different data rate. For example, when the second WLAN device 202 utilizes two BSSs, the second WLAN device 202 may transmit a first beacon frame that indicates support for an OFDM data rate via a first BSS having a first SSID, and a second beacon frame that indicates support for a non-OFDM data rate (or an 802.11b data rate) via a second BSS having a second SSID. The first WLAN device 204 may receive the first beacon frame via the first BSS and the second beacon frame via the second BSS. The first WLAN device 204 may determine or ascertain which beacon frame to select, follow or adopt for subsequent communications depending on the data rate capabilities of the first WLAN device 204. For example, if the first WLAN device 204 supports only OFDM data rates, the first WLAN device 204 may select, follow or adopt the first beacon frame indicating support for the OFDM data rate via the first BSS. If the first WLAN device 204 supports only 802.11b data rates (such as 802.11b wideband rates and narrow band rates), the first WLAN device 204 may select, follow or adopt the second beacon frame indicating support for the non-OFDM data rate via the second BSS. If the first WLAN device 204 supports both OFDM and non-OFDM data rates, the first WLAN device 204 may select, follow or adopt the second beacon frame indicating support for the 802.11b data rates via the second BSS. In some implementations, if all the WLAN devices (including the first WLAN device 204) connected to the second WLAN device 202 support 802.11b data rates, the second WLAN device 202 may use a single BSS and transmit a single beacon via the BSS that indicates support for the 802.11b data rates.

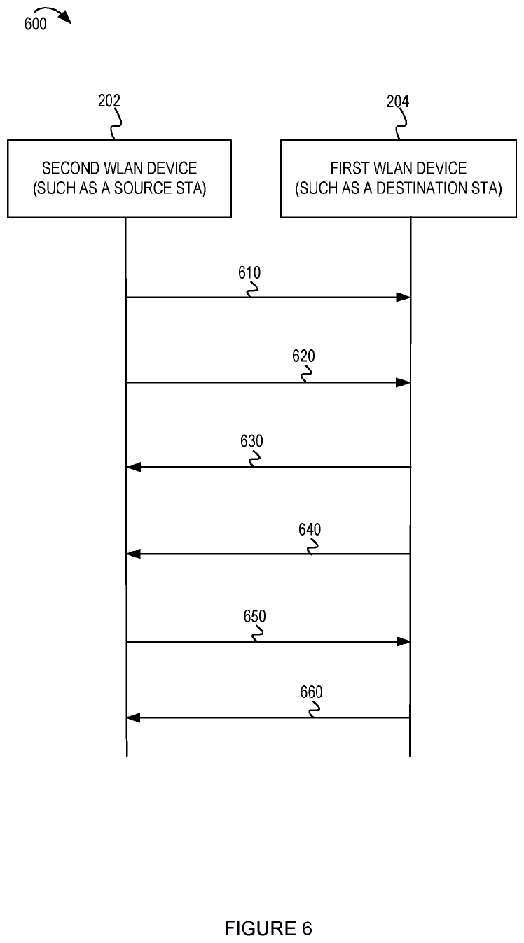

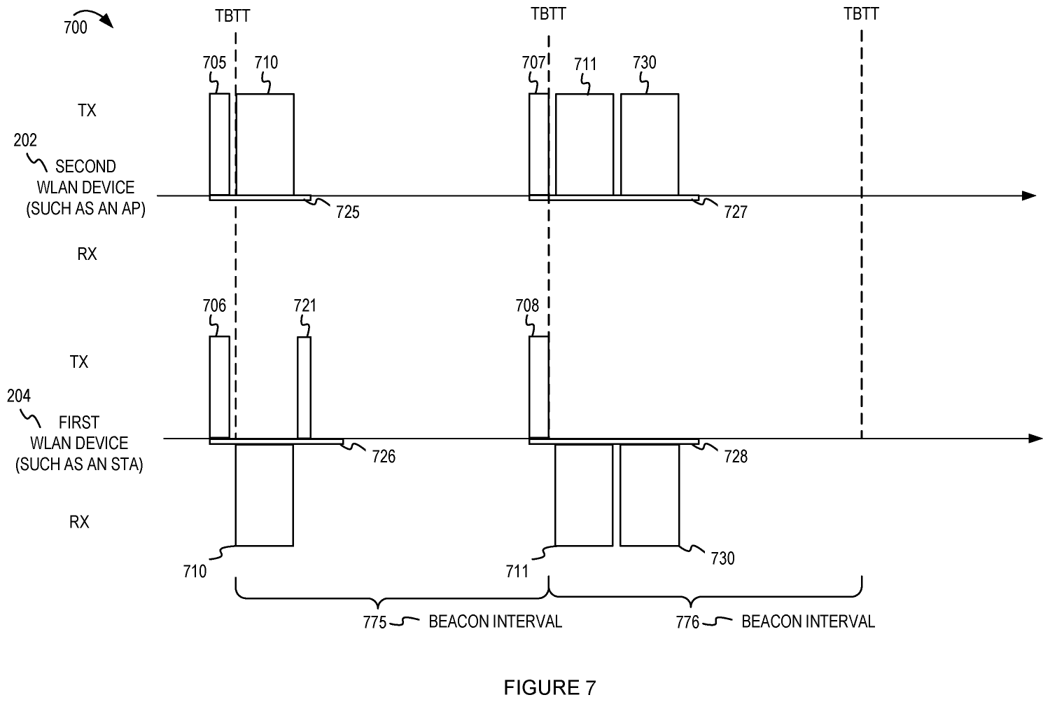

In some implementations, the second WLAN device 202 and the first WLAN device 204 may implement a 4-way protection mechanism using control frames for reducing interference from neighboring WLAN devices and improving coexistence. The control frames may include clear to send (CTS) frames, request to send (RTS) frames, and CTS-to-Self (CTS2Self) frames. In some implementations, the second WLAN device 202 and the first WLAN device 204 may transmit OFDM CTS2Self frames, 802.11b CTS frames, and 802.11b RTS frames to silence neighboring WLAN devices, as described further herein with reference to FIG. 6. For example, the second WLAN device 202 and the first WLAN device 204 may transmit the control frames to stop the neighboring WLAN devices from performing any communications during a network vector allocation (NAV) duration associated with the transmitted control frame in order to prevent or reduce interference. After silencing the neighboring WLAN devices, the second WLAN device 202 and the first WLAN device 204 may exchange data frames using 802.11b wideband or narrow band rates via the 5 GHz or 6 GHz bands. In some implementations, the second WLAN device 202 and the first WLAN device 204 may implement a beacon frame protection mechanism using control frames for reducing interference from neighboring WLAN devices and improving coexistence, as described further herein with reference to FIG. 7. In some implementations, the non-OFDM data rates, which may include various non-conformant data rates, may be used in one or more non-2.4 GHz bands (such as one or more of the 3.5 GHz, 5 GHz, 6 GHz, 45 GHz, and 60 GHz bands) for wireless range extension, while implementing protection mechanisms that address coexistence issues with conformant networks.

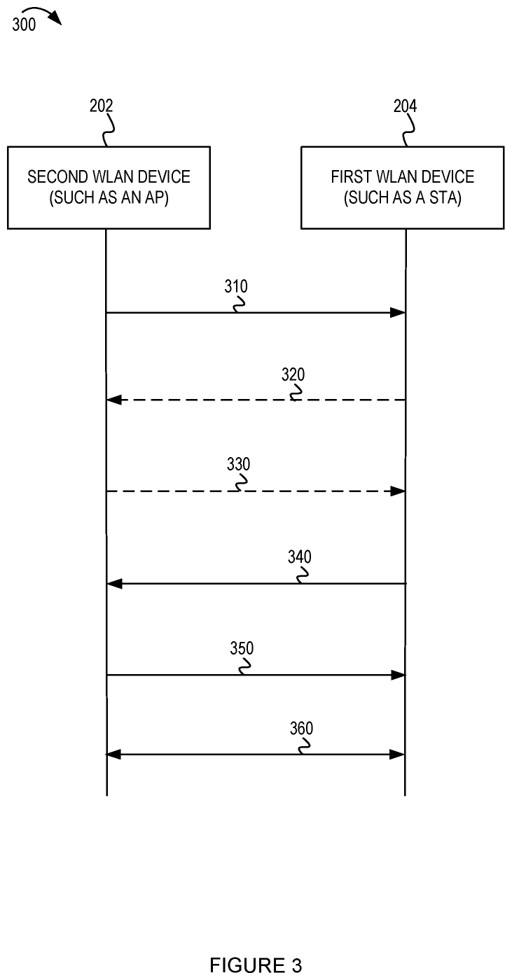

FIG. 3 shows an example message flow diagram 300 that shows an exchange of management frames between a first WLAN device and a second WLAN device that advertise support for 802.11b data rates in one or more non-2.4 GHz bands, such as one or more of the 3.5 GHz, 5 GHz, 6 GHz, 45 GHz, and 60 GHz bands. The management frames may include beacon frames, probe request frames, probe response frames, association request frames, and association response frames. The message flow diagram 300 includes the first WLAN device 204 and the second WLAN device 202 that are described in FIG. 2.

At 310, in some implementations, the second WLAN device 202 may transmit a beacon frame to the first WLAN device 204 that indicates support for the 802.11b data rates in one or more of the non-2.4 GHz bands, such as the 5 GHz and 6 GHz bands. The first WLAN device 204 may passively scan for beacon frames when the first WLAN device 204 is search for a wireless communication network.

At 320, in some implementations, when the first WLAN device 204 is actively scanning for a network, the first WLAN device 204 may transmit a probe request frame to the second WLAN device 202 that indicates support for the 802.11b data rates in one or more of the non-2.4 GHz bands.

At 330, after the second WLAN device 202 receives the probe request frame, the second WLAN device 202 may transmit a probe response frame to the first WLAN device 204 that indicates support for the 802.11b data rates in one or more of the non-2.4 GHz bands.

At 340, after the first WLAN device 204 receives a beacon frame or a probe response frame, the first WLAN device 204 may transmit an association request frame to the second WLAN device 202. In some implementations, the association request frame may indicate support for the 802.11b data rates in one or more of the non-2.4 GHz bands.

At 350, after the second WLAN device 202 receives the association request frame, the second WLAN device 202 may transmit an association response frame to the first WLAN device 204. In some implementations, the association response frame may indicate support for the 802.11b data rates in one or more of the non-2.4 GHz bands.

In some implementations, the beacon frames, probe request frames, probe response frames, association request frames, and association response frames may indicate support for the 802.11b data rates in one or more of the non-2.4 GHz bands using one or more new bits, one or more new fields, one or more existing fields in an existing IE (or existing vendor IE), or a new IE (or new vendor IE).

At 360, after completing the association process, the first WLAN device 204 and the second WLAN device 202 may exchange data frames using 802.11b data rates in one or more of the non-2.4 GHz bands.

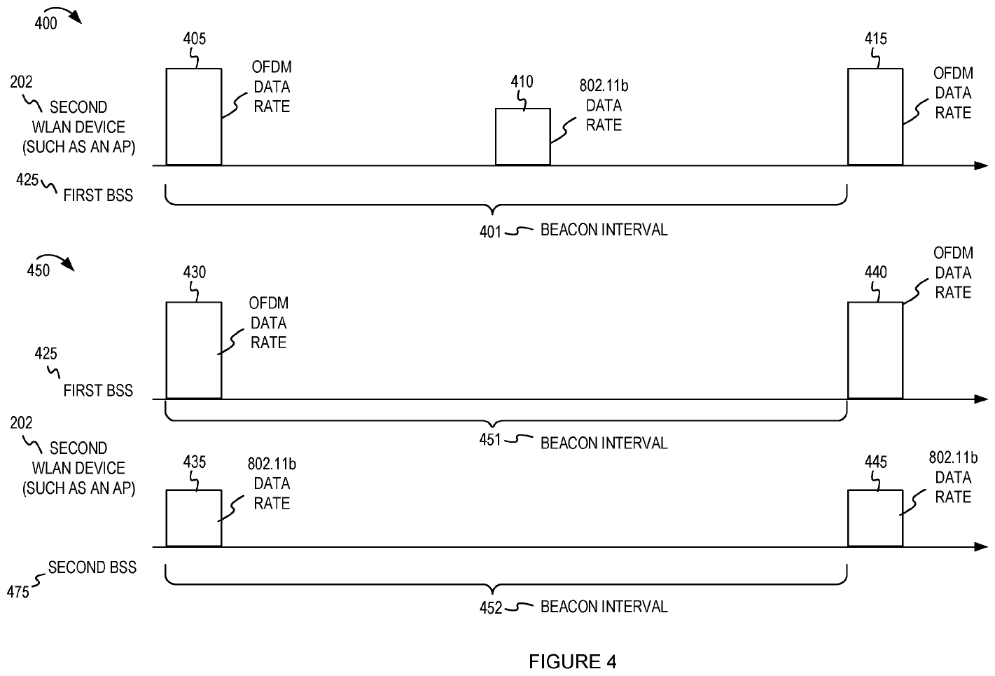

FIG. 4 shows example conceptual beacon frame diagrams 400 and 450 that show beacon frames that may be transmitted by the second WLAN device for one-to-N communications.

In some implementations, as shown in beacon frame diagram 400, the second WLAN device 202 may implement a beacon interval 401 with two separate beacon frames (which may be referred to as dual beacon frames) using a single BSS (such as a first BSS 425) for one-to-N communications. For example, the second WLAN device 202 may transmit a first beacon frame 405 that indicates support for an OFDM data rate and a second beacon frame 410 that indicates support for an 802.11b data rate (or a non-OFDM data rate) during the beacon interval 401 associated with the first BSS 425. In the next instance of the beacon interval 401, the second WLAN device 202 also may transmit the two beacon frames, such as the beacon frame 415 that indicates support for OFDM data rates and another beacon frame (not shown) that indicates support for 802.11b data rates. In some implementations, a WLAN device (such as the first WLAN device 204) that receives the first beacon frame 405 and the second beacon frame 410 may determine or ascertain which beacon frame to select, follow or adopt for subsequent communications depending on the data rate capabilities of the first WLAN device 204. For example, if the first WLAN device 204 supports only OFDM data rates, the first WLAN device 204 may select, follow or adopt the first beacon frame 405 indicating support for the OFDM data rate. If the first WLAN device 204 supports only 802.11b data rates (such as 802.11b wideband rates and narrow band rates), the first WLAN device 204 may select, follow or adopt the second beacon frame 410 indicating support for the 802.11b data rate. In some implementations, if the first WLAN device 204 supports both OFDM and non-OFDM data rates, the first WLAN device 204 may select, follow or adopt the second beacon frame 410 indicating support for the 802.11b data rates.

In some implementations, as shown in beacon frame diagram 450, the second WLAN device 202 may utilize two BSSs to transmit two separate beacon frames for one-to-N communications. For example, the second WLAN device 202 may transmit a first beacon frame 430) that indicates support for an OFDM data rate via the first BSS 425 having a first SSID, and a second beacon frame 435 that indicates support for an 802.11b data rate (or a non-OFDM data rate) via a second BSS 475 having a second SSID. The first beacon frame 430 may be transmitted during a first beacon interval 451 associated with the first BSS 425, and the second beacon frame 435 may be transmitted during a second beacon interval 452 associated with the second BSS 475. In the next instance of the first beacon interval 451, the second WLAN device 202 also may transmit the beacon frame 440 that indicates support for OFDM data rates. In the next instance of the second beacon interval 452, the second WLAN device 202 also may transmit the beacon frame 445 that indicates support for an 802.11b data rate. In some implementations, a WLAN device (such as the first WLAN device 204) that receives the first beacon frame 430 via the first BSS 425 and the second beacon frame 435 via the second BSS 475 may determine or ascertain which beacon frame to select, follow or adopt for subsequent communications depending on the data rate capabilities of the first WLAN device 204. For example, if the first WLAN device 204 supports only OFDM data rates, the first WLAN device 204 may select, follow or adopt the first beacon frame 430 indicating support for the OFDM data rate via the first BSS 425. If the first WLAN device 204 supports only 802.11b data rates (such as 802.11b wideband rates and narrow band rates), the first WLAN device 204 may select, follow or adopt the second beacon frame 435 indicating support for the non-OFDM data rate via the second BSS 475. If the first WLAN device 204 supports both OFDM and non-OFDM data rates, the first WLAN device 204 may select, follow or adopt the second beacon frame 435 indicating support for the 802.11b data rates via the second BSS 475.

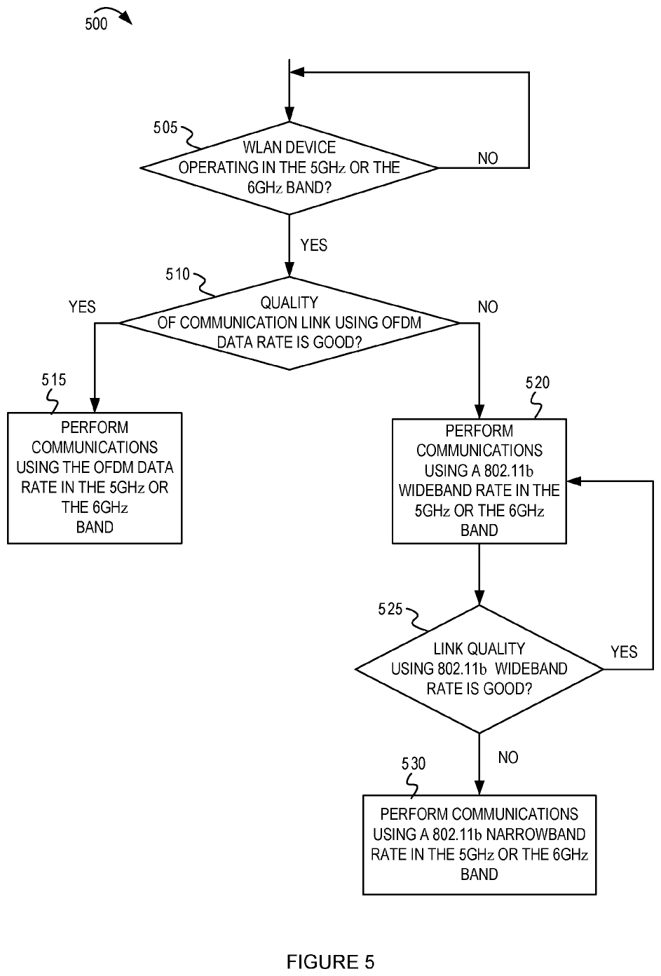

FIG. 5 shows a flowchart 500 with example operations performed by an apparatus of a WLAN device for implementing a data rate control mechanism. The WLAN device may be the first WLAN device 204 or the second WLAN device 202 described in FIG. 2, or both. In some implementations, the WLAN device may adjust the data rate that is used for the transmission of management frames, data frames, and other communications based on the link quality of a communication link. Although the example operations shown in flowchart 500 describe the WLAN device operating in either the 5 GHz band or the 6 GHz band, the WLAN device also may be operating in other non-2.4 GHz bands, such as the 3.5 GHz, the 45 GHz band, or the 60 GHz band (as described in FIG. 2).

In some implementations, at 505, the WLAN device may determine or ascertain whether it is operating in the 5 GHz band or the 6 GHz band. If the WLAN device is not operating in the 5 GHz band or the 6 GHz band, the WLAN device may continue to monitor whether it begins to operate in the 5 GHz band or the 6 GHz band. If the WLAN device is operating in the 5 GHz band or the 6 GHz band, the operations continue at 510.

At 510, the WLAN device may determine or ascertain whether the quality of a communication link that uses an OFDM data rate is good. For example, the WLAN device may determine or ascertain whether the quality of the communication link (which may be referred to as the link quality) is above a first link quality threshold. The link quality may be determined or ascertained by measuring the RSSI or the PER associated with the communication link, or both. In some implementations, the first link quality threshold may be an RSSI threshold or a PER threshold. As a non-limiting example, the first link quality threshold may be −80 dbm. If the link quality using the OFDM data rate is good (such as greater or equal to the first link quality threshold), the operations continue at 515. For example, the link quality using the OFDM data rate may be good when performing short range communications. As described in FIG. 2, short range communications may include communications that are within the range of OFDM data rates, such as communications within a distance of a few hundred meters. If the link quality using the OFDM data rate is poor (such as less than the quality threshold), the operations continue at 520. For example, the link quality using the OFDM data rate may be poor when performing long range communications. As described in FIG. 2, long range communications may include communications that are outside the range of OFDM data rates (and within the range of 802.11b data rates), such as communications at a distance greater than a few hundred meters.

At 515, the WLAN device may perform communications using the OFDM data rate in the 5 GHz band or the 6 GHz band.

At 520, the WLAN device may perform communications using an 802.11b wideband rate (or a non-OFDM wideband rate) in the 5 GHz band or the 6 GHz band.

At 525, the WLAN device may determine or ascertain whether the quality of the communication link that uses the 802.11b wideband rate is good. For example, the WLAN device may determine or ascertain whether link quality is above a second link quality threshold. As described herein, the link quality may be determined or ascertained by measuring the RSSI or the PER associated with the communication link, or both. In some implementations, the first link quality threshold may be an RSSI threshold or a PER threshold. As a non-limiting example, the second link quality threshold may be −90 dbm. If the link quality using the 802.11b wideband rate is good (such as greater or equal to the first link quality threshold), the WLAN device may continue to perform communications using the 802.11b wideband rate and monitor the link quality. For example, the link quality using the 802.11b wideband rate may be good when performing long range communications of a few kilometers, as described in FIG. 2. If the link quality using the 802.11b wideband rate is poor (such as less than the quality threshold), the operations continue at 530. For example, the link quality using the 802.11b wideband rate may be poor when performing long range communications that are greater than 8 kilometers, as described in FIG. 2.

At 530, the WLAN device may perform communications using an 802.11b narrow band rate (or a non-OFDM narrow band rate) in the 5 GHz band or the 6 GHz band. For example, the 802.11b narrow band rate may be an 802.11b quarter rate or half rate.

In some implementations, the data rate control mechanism also may change the data rate that the WLAN device uses when the link quality improves (not shown). For example, if the link quality improves, such as above a third link quality threshold, when using the 802.11b narrow band rate, the WLAN device may change to using the 802.11b wideband rate for performing communications. As a non-limiting example, the third link quality threshold may be −85 dbm. Also, if the link quality improves, such as above a fourth link quality threshold, when using the 802.11b wideband rate, the WLAN device may change to using the OFDM data rate for performing communications. As a non-limiting example, the fourth link quality threshold may be −75 dbm. In some implementations, the WLAN device may continuously monitor whether the link quality is above or below the first and second link quality thresholds to determine or ascertain whether to change the data rate that is used for communications.

FIG. 6 shows an example message flow diagram 600 that shows the transmission of control frames by a first WLAN device and a second WLAN device to implement a protection mechanism for reducing interference from neighboring WLAN devices and improving coexistence. For example, the first WLAN device and the second WLAN device may implement a 4-way protection mechanism using control frames for reducing interference from neighboring WLAN devices and improving coexistence. The control frames may include CTS frames, RTS frames, and CTS2Self frames. The message flow diagram 600 includes the first WLAN device 204 and the second WLAN device 202 that are described in FIG. 2. Although the second WLAN device 202 is shown as the source WLAN device and the first WLAN device 204 is shown as the destination WLAN device in FIG. 6, in some implementations the second WLAN device 202 may be the destination WLAN device and the first WLAN device 204 may be the source WLAN device.

At 610, the second WLAN device 202, which may be referred to as the source WLAN device, may transmit an OFDM CTS2Self frame to silence OFDM WLAN devices that are near the second WLAN device 202 (which may be referred to as neighboring OFDM WLAN devices). For example, the second WLAN device 202 may transmit a 20 MHz bandwidth (BW) OFDM CTS2Self frame. The second WLAN device 202 may silence the neighboring OFDM WLAN devices with the OFDM CTS2Self frame such that the neighboring OFDM WLAN devices do not perform any communications during a NAV duration associated with the OFDM CTS2Self frame in order to prevent or reduce interference.

At 620, the second WLAN device 202 may transmit an 802.11b RTS frame to the first WLAN device 204 to silence 802.11b WLAN devices that are near the second WLAN device 202 (which may be referred to as neighboring 802.11b WLAN devices). For example, the second WLAN device 202 may transmit an 802.11b wideband RTS frame. As another example, the second WLAN device 202 may transmit an 802.11b narrow band RTS frame. The second WLAN device 202 may silence the neighboring 802.11b wideband or narrow band WLAN devices with the 802.11b RTS frame such that the neighboring 802.11b wideband or narrow band WLAN devices do not perform any communications during a NAV duration associated with the 802.11b RTS frame in order to prevent or reduce interference.

At 630, the first WLAN device 204, which may be referred to as the destination WLAN device, may transmit an 802.11b CTS frame to the second WLAN device 202 to silence neighboring 802.11b WLAN devices. For example, the first WLAN device 204 may transmit an 802.11b wideband CTS frame. As another example, the first WLAN device 204 may transmit an 802.11b narrow band CTS frame. The first WLAN device 204 may silence the neighboring 802.11b wideband or narrow band WLAN devices with the 802.11b CTS frame such that the neighboring 802.11b wideband or narrow band WLAN devices do not perform any communications during a NAV duration associated with the 802.11b CTS frame in order to prevent or reduce interference.

At 640, the first WLAN device 204 may transmit an OFDM CTS2Self frame to silence the OFDM WLAN devices that are near the first WLAN device 204. For example, the first WLAN device 204 may transmit a 20 MHz BW OFDM CTS2Self frame. The first WLAN device 204 may silence the neighboring OFDM WLAN devices with the OFDM CTS2Self frame such that the neighboring OFDM WLAN devices do not perform any communications during a NAV duration associated with the OFDM CTS2Self frame in order to prevent or reduce interference.

At 650, the second WLAN device 202 may transmit one or more data frames to the first WLAN device 204 using 802.11b data rates. For example, the second WLAN device 202 may transmit one or more 802.11b wideband data frames to the first WLAN device 204. As another example, the second WLAN device 202 may transmit one or more 802.11b narrow band data frames to the first WLAN device 204.

At 660, the first WLAN device 204 may transmit an acknowledgment (ACK) frame to the second WLAN device 202 to indicate the first WLAN device 204 successfully received the one or more 802.11b data frames. For example, the first WLAN device 204 may transmit an 802.11b wideband ACK frame. As another example, the first WLAN device 204 may transmit an 802.11b narrow band ACK frame.

FIG. 7 shows another example conceptual diagram 700 that shows the transmission of control frames by a first WLAN device and a second WLAN device to implement a protection mechanism for reducing interference from neighboring WLAN devices and improving coexistence. The control frames may include CTS2Self frames. The conceptual diagram 700 includes the first WLAN device 204 and the second WLAN device 202 that are described in FIG. 2.

In some implementations, the second WLAN device 202 and the first WLAN device 204 may transmit OFDM CTS2Self frames 705 and 706 prior to the target beacon transmission time (TBTT) at the beginning of the beacon interval 775 in order to silence neighboring OFDM WLAN devices. For example, the second WLAN device 202 may transmit the OFDM CTS2Self frame 705 in order to silence neighboring OFDM WLAN devices such that the neighboring OFDM WLAN devices do not perform any communications during a NAV duration 725 associated with the OFDM CTS2Self frame 705 in order to prevent or reduce interference. The first WLAN device 204 may transmit the OFDM CTS2Self frame 706 in order to silence neighboring OFDM WLAN devices such that the neighboring OFDM WLAN devices do not perform any communications during a NAV duration 726 associated with the OFDM CTS2Self frame 706 in order to prevent or reduce interference.

After transmitting the OFDM CTS2Self frame 705, the second WLAN device 202 may transmit a beacon frame 710 to the first WLAN device 204. The first WLAN device 204 may receive the beacon frame 710. If the first WLAN device 204 receive the beacon frame 710) and doesn't have any buffer data, the first WLAN device 204 may transmit an OFDM contention-free end (CF-END) frame 721 to reset any remaining NAV duration 726.

In some implementations, the second WLAN device 202 and the first WLAN device 204 may transmit OFDM CTS2Self frames 707 and 708 prior to the TBTT at the beginning of the beacon interval 776 in order to silence neighboring OFDM WLAN devices. For example, the second WLAN device 202 may transmit the OFDM CTS2Self frame 707 in order to silence neighboring OFDM WLAN devices such that the neighboring OFDM WLAN devices do not perform any communications during a NAV duration 727 associated with the OFDM CTS2Self frame 707 in order to prevent or reduce interference. The first WLAN device 204 may transmit the OFDM CTS2Self frame 708 in order to silence neighboring OFDM WLAN devices such that the neighboring OFDM WLAN devices do not perform any communications during a NAV duration 728 associated with the OFDM CTS2Self frame 708 in order to prevent or reduce interference.

After transmitting the OFDM CTS2Self frame 707, the second WLAN device 202 may transmit a beacon frame 711 to the first WLAN device 204. The first WLAN device 204 may receive the beacon frame 711. If the first WLAN device 204 receive the beacon frame 711 indicating the second WLAN device 202 has one or more buffered data frames 730, the first WLAN device 204 may subsequently receive the buffered data frames 730 from the second WLAN device 202. In some implementations, the second WLAN device 202 may calculate the NAV duration 727 based on the buffered data frames 730 for the first WLAN device 204. If the first WLAN device 204 determines or ascertains that the remaining NAV duration 728 is not enough to receive the one or more buffered data frames 730, the first WLAN device 204 may transmit another OFDM CTS2Self frame (not shown) in order to extend the NAV duration for receiving the one or more buffered data frames 730.

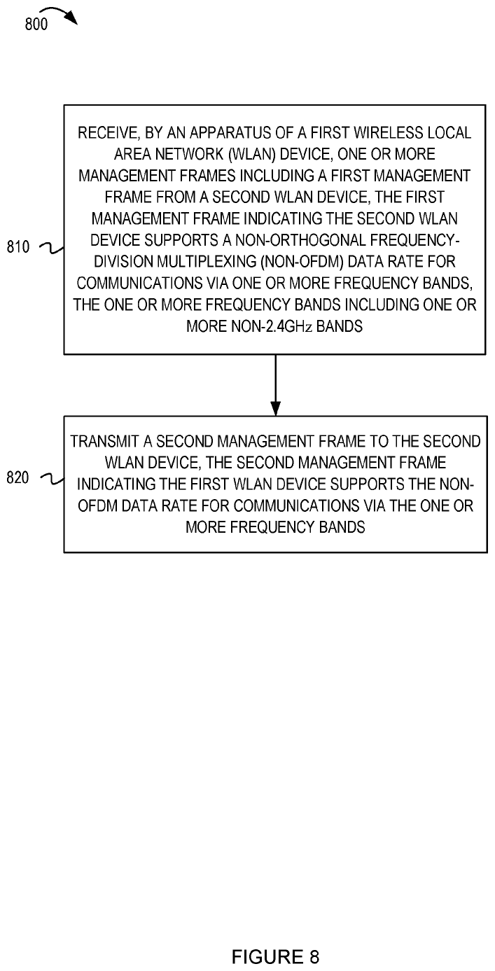

FIG. 8 depicts a flowchart 800 with example operations performed by an apparatus of a first WLAN device to implement range extension for one or more non-2.4 GHz bands.

At block 810, the apparatus of the first WLAN device may receive one or more management frames including a first management frame from a second WLAN device. The first management frame may indicate the second WLAN device supports a non-OFDM data rate for communications via one or more frequency bands. The one or more frequency bands may include one or more non-2.4 GHz bands. The one or more non-2.4 GHz bands may include one or more of the 3.5 GHz, 5 GHz, 6 GHz, 45 GHz, and 60 GHz bands.

At block 820, the apparatus of the first WLAN device may transmit a second management frame to the second WLAN device. The second management frame may indicate the first WLAN device supports the non-OFDM data rate for communications via the one or more frequency bands.

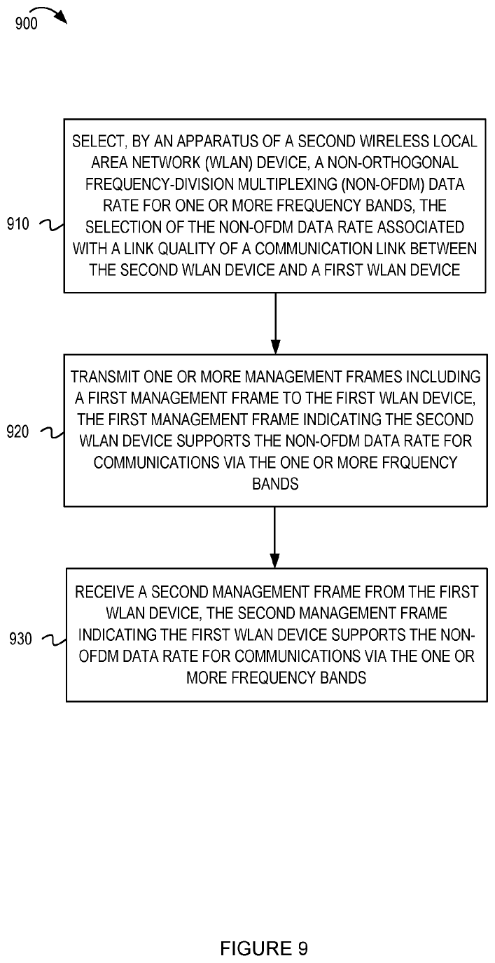

FIG. 9 depicts a flowchart 900 with example operations performed by an apparatus of a second WLAN device to implement range extension for one or more non-2.4 GHz bands.

At block 910, the apparatus of the second WLAN device may select a non-OFDM data rate for one or more frequency bands. The selection of the non-OFDM data rate may be associated with a link quality of a communication link between the second WLAN device and a first WLAN device.

At block 920, the apparatus of the second WLAN device may transmit one or more management frames including a first management frame to the first WLAN device. The first management frame may indicate the second WLAN device supports the non-OFDM data rate for communications via the one or more frequency bands.

At block 930, the apparatus of the second WLAN device may receive a second management frame from the first WLAN device. The second management frame may indicate the first WLAN device supports the non-OFDM data rate for communications via the one or more frequency bands.

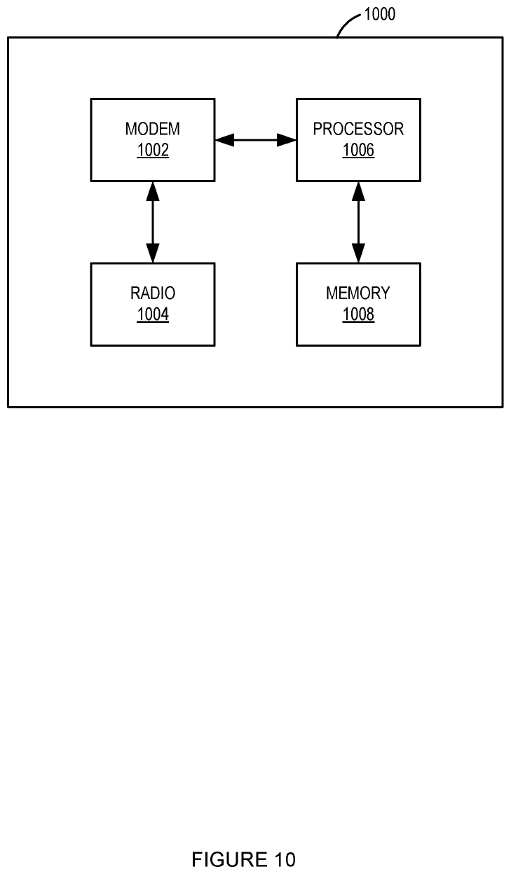

FIG. 10 shows a block diagram of an example wireless communication device 1000. In some implementations, the wireless communication device 1000 can be an example of a device for use in a STA such as one of the STAs 104 described herein. In some implementations, the wireless communication device 1000 can be an example of a device for use in an AP such as the AP 102 described herein. The wireless communication device 1000 may be generally referred to as an apparatus or a wireless communication apparatus. The wireless communication device 1000 is capable of transmitting (or outputting for transmission) and receiving wireless communications (for example, in the form of wireless packets). For example, the wireless communication device 1000 can be configured to transmit and receive packets in the form of PPDUs and MPDUs conforming to an IEEE 802.11 standard, such as that defined by the IEEE 802.11-2016 specification or amendments thereof including, but not limited to, 802.11ah, 802.11ad, 802.11ay, 802.11ax, 802.11az, 802.11ba and 802.11be.

The wireless communication device 1000 can be, or can include, a chip, system on chip (SoC), chipset, package or device that includes one or more modems 1002, for example, a Wi-Fi (IEEE 802.11 compliant) modem. In some implementations, the one or more modems 1002 (collectively “the modem 1002”) additionally include a WWAN modem (for example, a 3GPP 4G LTE or 5G compliant modem). In some implementations, the wireless communication device 1000 also includes one or more radios 1004 (collectively “the radio 1004”). In some implementations, the wireless communication device 1000 further includes one or more processors, processing blocks or processing elements (collectively “the processor 1006”) and one or more memory blocks or elements (collectively “the memory 1008”). In some implementations, the processor 1006 and the memory 1008 may be referred to as the processing system.

The modem 1002 can include an intelligent hardware block or device such as, for example, an application-specific integrated circuit (ASIC) among other possibilities. The modem 1002 is generally configured to implement a PHY layer. For example, the modem 1002 is configured to modulate packets and to output the modulated packets to the radio 1004 for transmission over the wireless medium. The modem 1002 is similarly configured to obtain modulated packets received by the radio 1004 and to demodulate the packets to provide demodulated packets. In addition to a modulator and a demodulator, the modem 1002 may further include digital signal processing (DSP) circuitry, automatic gain control (AGC), a coder, a decoder, a multiplexer and a demultiplexer. For example, while in a transmission mode, data obtained from the processor 1006 is provided to a coder, which encodes the data to provide encoded bits. The encoded bits are then mapped to points in a modulation constellation (using a selected MCS) to provide modulated symbols. The modulated symbols may then be mapped to a number N_{SS} of spatial streams or a number N_{STS} of space-time streams. The modulated symbols in the respective spatial or space-time streams may then be multiplexed, transformed via an inverse fast Fourier transform (IFFT) block, and subsequently provided to the DSP circuitry for Tx windowing and filtering. The digital signals may then be provided to a digital-to-analog converter (DAC). The resultant analog signals may then be provided to a frequency upconverter, and ultimately, the radio 1004. In implementations involving beamforming, the modulated symbols in the respective spatial streams are precoded via a steering matrix prior to their provision to the IFFT block.

While in a reception mode, digital signals received from the radio 1004 are provided to the DSP circuitry, which is configured to acquire a received signal, for example, by detecting the presence of the signal and estimating the initial timing and frequency offsets. The DSP circuitry is further configured to digitally condition the digital signals, for example, using channel (narrow band) filtering, analog impairment conditioning (such as correcting for I/Q imbalance), and applying digital gain to ultimately obtain a narrowband signal. The output of the DSP circuitry may then be fed to the AGC, which is configured to use information extracted from the digital signals, for example, in one or more received training fields, to determine an appropriate gain. The output of the DSP circuitry also is coupled with the demodulator, which is configured to extract modulated symbols from the signal and, for example, compute the logarithm likelihood ratios (LLRs) for each bit position of each subcarrier in each spatial stream. The demodulator is coupled with the decoder, which may be configured to process the LLRs to provide decoded bits. The decoded bits from all of the spatial streams are then fed to the demultiplexer for demultiplexing. The demultiplexed bits may then be descrambled and provided to the MAC layer (the processor 1006) for processing, evaluation or interpretation.

The radio 1004 generally includes at least one radio frequency (RF) transmitter (or “transmitter chain”) and at least one RF receiver (or “receiver chain”), which may be combined into one or more transceivers. For example, the RF transmitters and receivers may include various DSP circuitry including at least one power amplifier (PA) and at least one low-noise amplifier (LNA), respectively. The RF transmitters and receivers may in turn be coupled to one or more antennas. For example, in some implementations, the wireless communication device 1000 can include, or be coupled with, multiple transmit antennas (each with a corresponding transmit chain) and multiple receive antennas (each with a corresponding receive chain). The symbols output from the modem 1002 are provided to the radio 1004, which then transmits the symbols via the coupled antennas. Similarly, symbols received via the antennas are obtained by the radio 1004, which then provides the symbols to the modem 1002. In some implementations, the radio 1004 and the one or more antennas may form one or more network interfaces (which also may be referred to as “interfaces”).

The processor 1006 can include an intelligent hardware block or device such as, for example, a processing core, a processing block, a central processing unit (CPU), a microprocessor, a microcontroller, a digital signal processor (DSP), an application-specific integrated circuit (ASIC), a programmable logic device (PLD) such as a field programmable gate array (FPGA), discrete gate or transistor logic, discrete hardware components, or any combination thereof designed to perform the functions described herein. The processor 1006 processes information received through the radio 1004 and the modem 1002, and processes information to be output through the modem 1002 and the radio 1004 for transmission through the wireless medium. For example, the processor 1006 may implement a control plane and MAC layer configured to perform various operations related to the generation and transmission of MPDUs, frames or packets. The MAC layer is configured to perform or facilitate the coding and decoding of frames, spatial multiplexing, space-time block coding (STBC), beamforming, and OFDMA resource allocation, among other operations or techniques. In some implementations, the processor 1006 may generally control the modem 1002 to cause the modem to perform various operations described above.

The memory 1008 can include tangible storage media such as random-access memory (RAM) or read-only memory (ROM), or combinations thereof. The memory 1008 also can store non-transitory processor-or computer-executable software (SW) code containing instructions that, when executed by the processor 1006, cause the processor to perform various operations described herein for wireless communication, including the generation, transmission, reception and interpretation of MPDUs, frames or packets. For example, various functions of components disclosed herein, or various blocks or steps of a method, operation, process or algorithm disclosed herein, can be implemented as one or more modules of one or more computer programs.

In some implementations, the wireless communication device 1000 may include a sounding signal unit (not shown). The sounding signal unit may be similar to the sounding signal unit 212 or the sounding signal unit 222 described with reference to FIGS. 2 and 3, and may implement any of the RF sensing techniques described herein. In some implementations, the sounding signal unit may be implemented by the processor 1006 and the memory 1008 (which may be referred to as the processing system). The memory 1008 can include computer instructions executable by the processor 1006 to implement the functionality of the sounding signal unit. Any of these functionalities may be partially (or entirely) implemented in hardware or on the processor 1006.

In some implementations, the wireless communication device 1000 may include an RF sensing unit (not shown). The RF sensing unit may be similar to the RF sensing unit 214 or the RF sensing unit 224 described with reference to FIGS. 2 and 3. and may implement any of the RF sensing techniques described herein. In some implementations, the RF sensing unit may be implemented by the processor 1006 and the memory 1008 (which may be referred to as the processing system). The memory 1008 can include computer instructions executable by the processor 1006 to implement the functionality of the RF sensing unit. Any of these functionalities may be partially (or entirely) implemented in hardware or on the processor 1006.

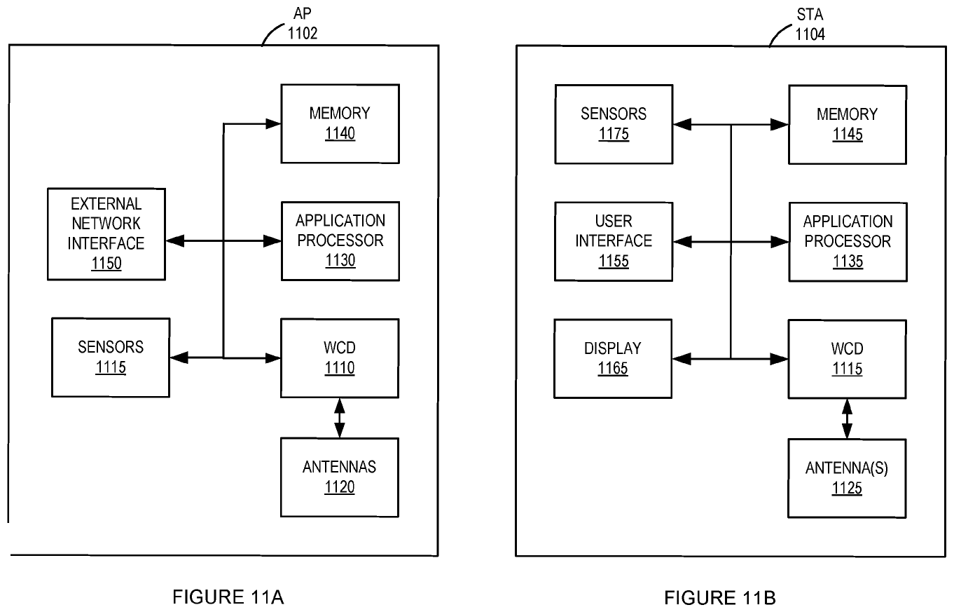

FIG. 11A shows a block diagram of an example AP 1102. For example, the AP 1102 can be an example implementation of the AP 102 described herein. The AP 1102 includes a wireless communication device (WCD) 1110. For example, the wireless communication device 1110 may be an example implementation of the wireless communication device 1000 described with reference to FIG. 10. The AP 1102 also includes multiple antennas 1120 coupled with the wireless communication device 1110 to transmit and receive wireless communications. In some implementations, the AP 1102 additionally includes an application processor 1130 coupled with the wireless communication device 1110, and a memory 1140 coupled with the application processor 1130. The AP 1102 further includes at least one external network interface 1150 that enables the AP 1102 to communicate with a core network or backhaul network to gain access to external networks including the Internet. For example, the external network interface 1150 may include one or both of a wired (for example, Ethernet) network interface and a wireless network interface (such as a WWAN interface). In some implementations, the AP 1102 may further include one or more sensors 1115, such as, for example, one or more inertial sensors, accelerometers, temperature sensors, pressure sensors, or altitude sensors. Ones of the aforementioned components can communicate with other ones of the components directly or indirectly. over at least one bus. The AP 1102 further includes a housing that encompasses the wireless communication device 1110, the application processor 1130, the memory 1140, and at least portions of the antennas 1120 and external network interface 1150.

FIG. 11B shows a block diagram of an example STA 1104. For example, the STA 1104 can be an example implementation of the STA 104 described herein. The STA 1104 includes a wireless communication device 1115. For example, the wireless communication device 1115 may be an example implementation of the wireless communication device 1000 described with reference to FIG. 10. The STA 1104 also includes one or more antennas 1125 coupled with the wireless communication device 1115 to transmit and receive wireless communications. The STA 1104 additionally includes an application processor 1135 coupled with the wireless communication device 1115, and a memory 1145 coupled with the application processor 1135. In some implementations, the STA 1104 further includes a user interface (UI) 1155 (such as a touchscreen or keypad) and a display 1165, which may be integrated with the UI 1155 to form a touchscreen display. In some implementations, the STA 1104 may further include one or more sensors 1175 such as, for example, one or more inertial sensors, accelerometers, temperature sensors, pressure sensors, or altitude sensors. Ones of the aforementioned components can communicate with other ones of the components directly or indirectly, over at least one bus. The STA 1104 further includes a housing that encompasses the wireless communication device 1115, the application processor 1135, the memory 1145, and at least portions of the antennas 1125, UI 1155, and display 1165.

FIGS. 1-11 and the operations described herein are examples meant to aid in understanding example implementations and should not be used to limit the potential implementations or limit the scope of the claims. Some implementations may perform additional operations, fewer operations, operations in parallel or in a different order, and some operations differently.

The foregoing disclosure provides illustration and description but is not intended to be exhaustive or to limit the aspects to the precise form disclosed. Modifications and variations may be made in light of the above disclosure or may be acquired from practice of the aspects. While the aspects of the disclosure have been described in terms of various examples, any combination of aspects from any of the examples is also within the scope of the disclosure. The examples in this disclosure are provided for pedagogical purposes. Alternatively, or in addition to the other examples described herein, examples include any combination of the following implementation options.

Clause 1. One aspect of the subject matter described in this disclosure can be implemented in a method for wireless communication performed by an apparatus of a first WLAN device. The method may include receiving one or more management frames including a first management frame from a second WLAN device. The first management frame may indicate the second WLAN device supports a non-OFDM data rate for communications via one or more frequency bands. The one or more frequency bands may include one or more non-2.4 GHz bands. The method may include transmitting a second management frame to the second WLAN device. The second management frame may indicate the first WLAN device supports the non-OFDM data rate for communications via the one or more frequency bands.

Clause 2. The method of clause 1, where the non-OFDM data rate may be a data rate of a plurality of data rates associated with an IEEE 802.11b standard, and the one or more non-2.4 GHz bands may include one or more of a 3.5 GHz band, a 5 GHz band, a 6 GHz band, a 45 GHz band, and a 60 GHz band.

Clause 3. The method of any one or more of clauses 1-2, where the non-OFDM data rate may be a data rate of a plurality of non-conformant data rates, and the one or more non-2.4 GHz bands may include one or more of a 3.5 GHz band, a 5 GHz band, a 6 GHz band, a 45 GHz band, and a 60 GHz band.

Clause 4. The method of any one or more of clauses 1-3, where the method may further include receiving a third management frame indicating the second WLAN device supports an OFDM data rate for communications via the one or more frequency bands, and selecting either the non-OFDM data rate associated with the first management frame or the OFDM data rate associated with the third management frame for communications via the one or more frequency bands.

Clause 5. The method of any one or more of clauses 1-4, where the method may further include selecting the non-OFDM data rate associated with the first management frame. The selection may be associated with a link quality of a communication link between the first WLAN device and the second WLAN device and data rates supported by the first WLAN device.

Clause 6. The method of any one or more of clauses 1-5, where the first management frame may be a first beacon frame and the third management frame may be a second beacon frame. The first beacon frame and the second beacon frame may be received by the first WLAN device periodically within a beacon time interval.

Clause 7. The method of any one or more of clauses 1-6, where the method may further include receiving the first management frame via a first BSS associated with the non-OFDM data rate. The first management frame may indicate the second WLAN device supports the non-OFDM data rate for communications via the one or more frequency bands. The method may further include receiving a third management frame via a second BSS associated with an OFDM data rate. The third management frame may indicate the second WLAN device supports an OFDM data rate for communications via the one or more frequency bands. The method may further include selecting either the first BSS associated with the non-OFDM data rate and the first management frame or the second BSS associated with the OFDM data rate and the third management frame.

Clause 8. The method of any one or more of clauses 1-7, where the method may further include selecting the first BSS associated with the non-OFDM data rate. The selection may be associated with a link quality of a communication link between the first WLAN device and the second WLAN device and data rates supported by the first WLAN device.

Clause 9. The method of any one or more of clauses 1-8, where the first management frame may be one of a beacon frame, a probe response frame, an association response frame, a probe request frame, an association request frame, a reassociation request frame, and a vendor-defined frame, and the second management frame may be one of a beacon frame, a probe response frame, an association response frame, a probe request frame, an association request frame, a reassociation request frame, and a vendor-defined frame.

Clause 10. The method of any one or more of clauses 1-9, where the first WLAN device and the second WLAN device may be WLAN devices configured to implement one or more of an infrastructure mode, an ad hoc mode, a P2P mode, and a NAN mode in a wireless communication network.

Clause 11. The method of any one or more of clauses 1-10, where the method may further include receiving a first control frame from the second WLAN device. The first control frame may cause neighboring non-OFDM WLAN devices of the second WLAN device to stop performing communications. The method may further include transmitting a second control frame to the second WLAN device in response to receiving the first control frame. The second control frame may cause neighboring non-OFDM WLAN devices of the first WLAN device to stop performing communications. The method may further include transmitting a third control frame to cause neighboring OFDM WLAN devices of the first WLAN device to stop performing communications, and receiving, from the second WLAN device, one or more data frames that use the non-OFDM data rate via a selected one of the one or more non-2.4 GHz bands.

Clause 12. The method of any one or more of clauses 1-11, where the first control frame may be a non-OFDM RTS frame, the second control frame may be a non-OFDM CTS frame, and the third control frame may be an OFDM CTS2Self frame.

Clause 13. The method of any one or more of clauses 1-12, where the method may further include transmitting an OFDM CTS2Self frame prior to a TBTT. The OFDM CTS2Self frame may cause neighboring OFDM WLAN devices of the first WLAN device to stop performing communications. The method may further include receiving a beacon frame indicating the second WLAN device has one or more buffered data frames for the first WLAN device: and receiving the one or more buffered data frames from the second WLAN device.

Clause 14. Another aspect of the subject matter described in this disclosure can be implemented in a method for wireless communication performed by an apparatus of a second WLAN device. The method may include selecting a non-OFDM data rate for one or more frequency bands. The selection of the non-OFDM data rate may be associated with a link quality of a communication link between the second WLAN device and a first WLAN device. The method may include transmitting one or more management frames including a first management frame to the first WLAN device. The first management frame may indicate the second WLAN device supports the non-OFDM data rate for communications via the one or more frequency bands. The method may include receiving a second management frame from the first WLAN device. The second management frame may indicate the first WLAN device supports the non-OFDM data rate for communications via the one or more frequency bands.

Clause 15. The method of clause 14, where the non-OFDM data rate may be a data rate of a plurality of data rates associated with an IEEE 802.11b standard, and the one or more frequency bands may include one or more non-2.4 GHz bands. The one or more non-2.4 GHz bands may include one or more of a 3.5 GHz band, a 5 GHz band, a 6 GHz band, a 45 GHz band, and a 60 GHz band.

Clause 16. The method of any one or more of clauses 14-15, where the non-OFDM data rate may be a data rate of a plurality of non-conformant data rates, and the one or more frequency bands may include one or more non-2.4 GHz bands. The one or more non-2.4 GHz bands may include one or more of a 3.5 GHz band, a 5 GHz band, a 6 GHz band, a 45 GHz band, and a 60 GHz band.

Clause 17. The method of any one or more of clauses 14-16, where the method may further include transmitting a third management frame to the first WLAN device. The third management frame may indicate the second WLAN device supports an OFDM data rate for communications via the one or more frequency bands.

Clause 18. The method of any one or more of clauses 14-17, where the method may further include transmitting the first management frame to the first WLAN device via a first BSS associated with the non-OFDM data rate. The first management frame may indicate the second WLAN device supports the non-OFDM data rate for communications via the one or more frequency bands. The method may further include transmitting a third management frame to the first WLAN device via a second BSS associated with an OFDM data rate. The third management frame may indicate the second WLAN device supports an OFDM data rate for communications via the one or more frequency bands.

Clause 19. The method of any one or more of clauses 14-18, where the method may further include selecting a frequency band of the one or more frequency bands, and selecting either the non-OFDM data rate or the OFDM data rate for communications via the selected frequency band. The selection of either the non-OFDM data rate or the OFDM data rate may be associated with the link quality of the communication link between the second WLAN device and the first WLAN device.

Clause 20. The method of any one or more of clauses 14-19, where the method may further include, in response to selecting the non-OFDM data rate, selecting either a wideband non-OFDM data rate or a narrow band non-OFDM data rate. The selection of either the wideband non-OFDM data rate or the narrow band non-OFDM data rate may be associated with the link quality of the communication link between the second WLAN device and the first WLAN device.

Clause 21. The method of any one or more of clauses 14-20, where the method may further include transmitting a first control frame to cause neighboring OFDM WLAN devices of the second WLAN device to stop performing communications, and transmitting a second control frame to the first WLAN device. The second control frame may cause neighboring non-OFDM WLAN devices of the second WLAN device to stop performing communications. The method may include receiving a third control frame from the first WLAN device in response to transmitting the second control frame. The third control frame may cause neighboring non-OFDM WLAN devices of the first WLAN device to stop performing communications. The method may include transmitting one or more data frames that use the non-OFDM data rate via a selected one of the one or more frequency bands.

Clause 22. The method of any one or more of clauses 14-21, where the first control frame may be an OFDM CTS2Self frame, the second control frame may be a non-OFDM RTS frame, and the third control frame may be a non-OFDM CTS frame.

Clause 23. Another aspect of the subject matter described in this disclosure can be implemented in an apparatus of a first WLAN device. The apparatus may include one or more processors and one or more interfaces. The one or more interfaces may be configured to receive one or more management frames including a first management frame from a second WLAN device. The first management frame may indicate the second WLAN device supports a non-OFDM data rate for communications via one or more frequency bands. The one or more frequency bands may include one or more non-2.4 GHzb bands. The one or more interfaces may be configured to transmit a second management frame to the second WLAN device. The second management frame may indicate the first WLAN device supports the non-OFDM data rate for communications via the one or more frequency bands.

Clause 24. The apparatus of clause 23, where the non-OFDM data rate may be a data rate of a plurality of data rates associated with an IEEE 802.11b standard, and the one or more non-2.4 GHz bands may include one or more of a 3.5 GHz band, a 5 GHz band, a 6 GHz band, a 45 GHz band, and a 60 GHz band.

Clause 25. The apparatus of any one or more of clauses 23-24, where the non-OFDM data rate may be a data rate of a plurality of non-conformant data rates, and the one or more non-2.4 GHz bands may include one or more of a 3.5 GHz band, a 5 GHz band, a 6 GHz band, a 45 GHz band, and a 60 GHz band.

Clause 26. The apparatus of any one or more of clauses 23-25, where the one or more interfaces may be configured to receive a third management frame indicating the second WLAN device supports an OFDM data rate for communications via the one or more frequency bands, and the one or more processors may be configured to select either the non-OFDM data rate associated with the first management frame or the OFDM data rate associated with the third management frame for communications via the one or more frequency bands.

Clause 27. The apparatus of any one or more of clauses 23-26, where the one or more processors may be configured to select the non-OFDM data rate associated with the first management frame. The selection may be associated with a link quality of a communication link between the first WLAN device and the second WLAN device and data rates supported by the first WLAN device.

Clause 28. The apparatus of any one or more of clauses 23-27, where the first management frame may be a first beacon frame and the third management frame may be a second beacon frame. The first beacon frame and the second beacon frame may be received by the one or more interfaces of the first WLAN device periodically within a beacon time interval.

Clause 29. The apparatus of any one or more of clauses 23-28, where the one or more interfaces may be configured to receive the first management frame via a first BSS associated with the non-OFDM data rate. The first management frame may indicate the second WLAN device supports the non-OFDM data rate for communications via the one or more frequency bands. The one or more interfaces may be configured to receive a third management frame via a second BSS associated with an OFDM data rate. The third management frame may indicate the second WLAN device supports an OFDM data rate for communications via the one or more frequency bands. The one or more processors may be configured to select either the first BSS associated with the non-OFDM data rate and the first management frame or the second BSS associated with the OFDM data rate and the third management frame.

Clause 30. The apparatus of any one or more of clauses 23-29, where the one or more processors may be configured to select the first BSS associated with the non-OFDM data rate. The selection may be associated with a link quality of a communication link between the first WLAN device and the second WLAN device and data rates supported by the first WLAN device.

Clause 31. The apparatus of any one or more of clauses 23-30, where the first management frame may be one of a beacon frame, a probe response frame, an association response frame, a probe request frame, an association request frame, a reassociation request frame, and a vendor-defined frame, and the second management frame may be one of a beacon frame, a probe response frame, an association response frame, a probe request frame, an association request frame, a reassociation request frame, and a vendor-defined frame.

Clause 32. The apparatus of any one or more of clauses 23-31, where the first WLAN device and the second WLAN device may be WLAN devices configured to implement one or more of an infrastructure mode, an ad hoc mode, a P2P mode, and a NAN mode in a wireless communication network.

Clause 33. The apparatus of any one or more of clauses 23-32, where the one or more interfaces may be configured to receive a first control frame from the second WLAN device. The first control frame may cause neighboring non-OFDM WLAN devices of the second WLAN device to stop performing communications. The one or more interfaces may be configured to transmit a second control frame to the second WLAN device in response to receiving the first control frame. The second control frame may cause neighboring non-OFDM WLAN devices of the first WLAN device to stop performing communications. The one or more interfaces may be configured to transmit a third control frame to cause neighboring OFDM WLAN devices of the first WLAN device to stop performing communications. The one or more interfaces may be configured to receive, from the second WLAN device, one or more data frames that use the non-OFDM data rate via a selected one of the one or more non-2.4 GHz bands.

Clause 34. The apparatus of any one or more of clauses 23-33, where the first control frame may be a non-OFDM RTS frame, the second control frame may be a non-OFDM CTS frame, and the third control frame may be an OFDM CTS2Self frame.

Clause 35. The apparatus of any one or more of clauses 23-34, where the one or more interfaces may be configured to transmit an OFDM CTS2Self frame prior to a TBTT. The OFDM CTS2Self frame may cause neighboring OFDM WLAN devices of the first WLAN device to stop performing communications. The one or more interfaces may be configured to receive a beacon frame indicating the second WLAN device has one or more buffered data frames for the first WLAN device, and the one or more interfaces may be configured to receive the one or more buffered data frames from the second WLAN device.

Clause 36. Another aspect of the subject matter described in this disclosure can be implemented in an apparatus of a second WLAN device. The apparatus may include one or more processors and one or more interfaces. The one or more processors may be configured to select a non-OFDM data rate for one or more frequency bands. The selection of the non-OFDM data rate may be associated with a link quality of a communication link between the second WLAN device and a first WLAN device. The one or more interfaces may be configured to transmit one or more management frames including a first management frame to the first WLAN device. The first management frame may indicate the second WLAN device supports the non-OFDM data rate for communications via the one or more frequency bands. The one or more interfaces may be configured to receive a second management frame from the first WLAN device. The second management frame may indicate the first WLAN device supports the non-OFDM data rate for communications via the one or more frequency bands.

Clause 37. The apparatus of clause 36, where the non-OFDM data rate may be a data rate of a plurality of data rates associated with an IEEE 802.11b standard, and the one or more frequency bands may include one or more non-2.4 GHz bands. The one or more non-2.4 GHz bands may include one or more of a 3.5 GHz band, a 5 GHz band, a 6 GHz band, a 45 GHz band, and a 60 GHz band.

Clause 38. The apparatus of any one or more of clauses 36-37, where the non-OFDM data rate may be a data rate of a plurality of non-conformant data rates, and the one or more frequency bands may include one or more non-2.4 GHz bands. The one or more non-2.4 GHz bands may include one or more of a 3.5 GHz band, a 5 GHz band, a 6 GHz band, a 45 GHz band, and a 60 GHz band.

Clause 39. The apparatus of any one or more of clauses 36-38, where the one or more interfaces may be configured to transmit a third management frame to the first WLAN device. The third management frame may indicate the second WLAN device supports an OFDM data rate for communications via the one or more frequency bands.

Clause 40. The apparatus of any one or more of clauses 36-39, where the one or more interfaces may be configured to transmit the first management frame to the first WLAN device via a first BSS associated with the non-OFDM data rate. The first management frame may indicate the second WLAN device supports the non-OFDM data rate for communications via the one or more frequency bands. The one or more interfaces may be configured to transmit a third management frame to the first WLAN device via a second BSS associated with an OFDM data rate. The third management frame may indicate the second WLAN device supports an OFDM data rate for communications via the one or more frequency bands.

Clause 41. The apparatus of any one or more of clauses 36-40, where the one or more processors may be configured to select a frequency band of the one or more frequency bands, and the one or more processors may be configured to select either the non-OFDM data rate or the OFDM data rate for communications via the selected frequency band. The selection of either the non-OFDM data rate or the OFDM data rate may be associated with the link quality of the communication link between the second WLAN device and the first WLAN device.

Clause 42. The apparatus of any one or more of clauses 36-41, where, in response to selection of the non-OFDM data rate, the one or more processors may be configured to select either a wideband non-OFDM data rate or a narrow band non-OFDM data rate. The selection of either the wideband non-OFDM data rate or the narrow band non-OFDM data rate may be associated with the link quality of the communication link between the second WLAN device and the first WLAN device.

Clause 43. The apparatus of any one or more of clauses 36-42, where the one or more interfaces may be configured to transmit a first control frame to cause neighboring OFDM WLAN devices of the second WLAN device to stop performing communications, and the one or more interfaces may be configured to transmit a second control frame to the first WLAN device. The second control frame may cause neighboring non-OFDM WLAN devices of the second WLAN device to stop performing communications. The one or more interfaces may be configured to receive a third control frame from the first WLAN device in response to transmitting the second control frame. The third control frame may cause neighboring non-OFDM WLAN devices of the first WLAN device to stop performing communications. The one or more interfaces may be configured to transmit one or more data frames that use the non-OFDM data rate via a selected one of the one or more frequency bands.

Clause 44. The apparatus of any one or more of clauses 36-43, where the first control frame may be an OFDM CTS2Self frame, the second control frame may be a non-OFDM RTS frame, and the third control frame may be a non-OFDM CTS frame.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, units, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, units, modules, circuits and processes described throughout. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single-or multi-chip processor, a digital signal processor (DSP), an application-specific integrated circuit (ASIC), a field-programmable gate array (FPGA) or other programmable logic device, discrete gate or transistor logic, discrete hardware components, or any combination thereof designed to perform the functions described herein. A general-purpose processor may be a microprocessor, or any conventional processor, controller, microcontroller, or state machine. A processor also may be implemented as a combination of computing devices, e.g., a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray™ disc where disks usually reproduce data magnetically, while discs reproduce data optically with lasers. Combinations also can be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein but are to be accorded the widest scope consistent with this disclosure, the principles and the novel features disclosed herein.

Additionally, a person having ordinary skill in the art will readily appreciate, the terms “upper” and “lower” are sometimes used for ease of describing the Figures, and indicate relative positions corresponding to the orientation of the Figure on a properly oriented page and may not reflect the proper orientation of any device as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example process in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. A method for wireless communication performed by an apparatus of a first wireless local area network (WLAN) device, comprising:
receiving one or more management frames including a first management frame from a second WLAN device, the first management frame indicating the second WLAN device supports a non-orthogonal frequency-division multiplexing (non-OFDM) data rate for communications via one or more frequency bands, the one or more frequency bands including one or more non-2.4 GHz bands; and
transmitting a second management frame to the second WLAN device, the second management frame indicating the first WLAN device supports the non-OFDM data rate for communications via the one or more frequency bands.

2. The method of claim 1, wherein the non-OFDM data rate is a data rate of a plurality of data rates associated with an IEEE 802.11b standard, and the one or more non-2.4 GHz bands includes one or more of a 3.5 GHz band, a 5 GHz band, a 6 GHz band, a 45 GHz band, and a 60 GHz band.

3. The method of claim 1, wherein the non-OFDM data rate is a data rate of a plurality of non-conformant data rates, and the one or more non-2.4 GHz bands includes one or more of a 3.5 GHz band, a 5 GHz band, a 6 GHz band, a 45 GHz band, and a 60 GHz band.

4. The method of claim 1, further comprising:
receiving a third management frame indicating the second WLAN device supports an OFDM data rate for communications via the one or more frequency bands; and
selecting either the non-OFDM data rate associated with the first management frame or the OFDM data rate associated with the third management frame for communications via the one or more frequency bands.

5. The method of claim 4, further comprising:
selecting the non-OFDM data rate associated with the first management frame, the selection associated with a link quality of a communication link between the first WLAN device and the second WLAN device and data rates supported by the first WLAN device.

6. The method of claim 4, wherein the first management frame is a first beacon frame and the third management frame is a second beacon frame, the first beacon frame and the second beacon frame being received by the first WLAN device periodically within a beacon time interval.

7. The method of claim 1, further comprising:
receiving the first management frame via a first BSS associated with the non-OFDM data rate, the first management frame indicating the second WLAN device supports the non-OFDM data rate for communications via the one or more frequency bands;
receiving a third management frame via a second BSS associated with an OFDM data rate, the third management frame indicating the second WLAN device supports an OFDM data rate for communications via the one or more frequency bands; and
selecting either the first BSS associated with the non-OFDM data rate and the first management frame or the second BSS associated with the OFDM data rate and the third management frame.

8. The method of claim 7, further comprising:
selecting the first BSS associated with the non-OFDM data rate, the selection associated with a link quality of a communication link between the first WLAN device and the second WLAN device and data rates supported by the first WLAN device.

9. A method for wireless communication performed by an apparatus of a second wireless local area network (WLAN) device, comprising:
selecting a non-orthogonal frequency-division multiplexing (non-OFDM) data rate for one or more frequency bands, the selection of the non-OFDM data rate associated with a link quality of a communication link between the second WLAN device and a first WLAN device;
transmitting one or more management frames including a first management frame to the first WLAN device, the first management frame indicating the second WLAN device supports the non-OFDM data rate for communications via the one or more frequency bands; and
receiving a second management frame from the first WLAN device, the second management frame indicating the first WLAN device supports the non-OFDM data rate for communications via the one or more frequency bands.

10. The method of claim 9, further comprising:
transmitting a third management frame to the first WLAN device, the third management frame indicating the second WLAN device supports an OFDM data rate for communications via the one or more frequency bands.

11. The method of claim 9, further comprising:
transmitting the first management frame to the first WLAN device via a first BSS associated with the non-OFDM data rate, the first management frame indicating the second WLAN device supports the non-OFDM data rate for communications via the one or more frequency bands; and
transmitting a third management frame to the first WLAN device via a second BSS associated with an OFDM data rate, the third management frame indicating the second WLAN device supports an OFDM data rate for communications via the one or more frequency bands.

12. The method of claim 11, further comprising:
selecting a frequency band of the one or more frequency bands; and
selecting either the non-OFDM data rate or the OFDM data rate for communications via the selected frequency band, the selection of either the non-OFDM data rate or the OFDM data rate associated with the link quality of the communication link between the second WLAN device and the first WLAN device.

13. The method of claim 12, further comprising:
in response to selecting the non-OFDM data rate, selecting either a wideband non-OFDM data rate or a narrowband non-OFDM data rate, the selection of either the wideband non-OFDM data rate or the narrowband non-OFDM data rate associated with the link quality of the communication link between the second WLAN device and the first WLAN device.

14. An apparatus of a first wireless local area network (WLAN) device, comprising:
one or more processors; and
one or more interfaces configured to:
receive one or more management frames including a first management frame from a second WLAN device, the first management frame indicating the second WLAN device supports a non-orthogonal frequency-division multiplexing (non-OFDM) data rate for communications via one or more frequency bands, the one or more frequency bands including one or more non-2.4 GHz bands; and
transmit a second management frame to the second WLAN device, the second management frame indicating the first WLAN device supports the non-OFDM data rate for communications via the one or more frequency bands.

15. The apparatus of claim 14, wherein:
the one or more interfaces are configured to receive a third management frame indicating the second WLAN device supports an OFDM data rate for communications via the one or more frequency bands; and
the one or more processors are configured to select either the non-OFDM data rate associated with the first management frame or the OFDM data rate associated with the third management frame for communications via the one or more frequency bands.

16. The apparatus of claim 15, wherein:
the one or more processors are configured to select the non-OFDM data rate associated with the first management frame, the selection associated with a link quality of a communication link between the first WLAN device and the second WLAN device and data rates supported by the first WLAN device.

17. The apparatus of claim 15, wherein the first management frame is a first beacon frame and the third management frame is a second beacon frame, the first beacon frame and the second beacon frame being received by the one or more interfaces of the first WLAN device periodically within a beacon time interval.

18. The apparatus of claim 14, wherein:
the one or more interfaces are configured to receive the first management frame via a first BSS associated with the non-OFDM data rate, the first management frame indicating the second WLAN device supports the non-OFDM data rate for communications via the one or more frequency bands;
the one or more interfaces are configured to receive a third management frame via a second BSS associated with an OFDM data rate, the third management frame indicating the second WLAN device supports an OFDM data rate for communications via the one or more frequency bands; and
the one or more processors are configured to select either the first BSS associated with the non-OFDM data rate and the first management frame or the second BSS associated with the OFDM data rate and the third management frame.

19. The apparatus of claim 18, wherein:
the one or more processors are configured to select the first BSS associated with the non-OFDM data rate, the selection associated with a link quality of a communication link between the first WLAN device and the second WLAN device and data rates supported by the first WLAN device.

20. The apparatus of claim 14, wherein the first management frame is one of a beacon frame, a probe response frame, an association response frame, a probe request frame, an association request frame, a reassociation request frame, and a vendor-defined frame, and the second management frame is one of a beacon frame, a probe response frame, an association response frame, a probe request frame, an association request frame, a reassociation request frame, and a vendor-defined frame.

21. The apparatus of claim 14, wherein the first WLAN device and the second WLAN device are WLAN devices configured to implement one or more of an infrastructure mode, an ad hoc mode, a peer-to-peer (P2P) mode, and a Neighbor Awareness Networking (NAN) mode in a wireless communication network.

22. The apparatus of claim 14, wherein:
the one or more interfaces are configured to receive a first control frame from the second WLAN device, the first control frame to cause neighboring non-OFDM WLAN devices of the second WLAN device to stop performing communications;
the one or more interfaces are configured to transmit a second control frame to the second WLAN device in response to receiving the first control frame, the second control frame to cause neighboring non-OFDM WLAN devices of the first WLAN device to stop performing communications;
the one or more interfaces are configured to transmit a third control frame to cause neighboring OFDM WLAN devices of the first WLAN device to stop performing communications; and
the one or more interfaces are configured to receive, from the second WLAN device, one or more data frames that use the non-OFDM data rate via a selected one of the one or more non-2.4 GHz bands.

23. The apparatus of claim 22, wherein the first control frame is a non-OFDM request to send (RTS) frame, the second control frame is a non-OFDM clear to send (CTS) frame, and the third control frame is an OFDM CTS-to-Self (CTS2Self) frame.

24. The apparatus of claim 14, wherein:
the one or more interfaces are configured to transmit an OFDM CTS2Self frame prior to a target beacon transmission time (TBTT), the OFDM CTS2Self frame to cause neighboring OFDM WLAN devices of the first WLAN device to stop performing communications;
the one or more interfaces are configured to receive a beacon frame indicating the second WLAN device has one or more buffered data frames for the first WLAN device; and
the one or more interfaces are configured to receive the one or more buffered data frames from the second WLAN device.

25. An apparatus of a second wireless local area network (WLAN) device, comprising:
one or more processors configured to:
select a non-orthogonal frequency-division multiplexing (non-OFDM) data rate for one or more frequency bands, the selection of the non-OFDM data rate associated with a link quality of a communication link between the second WLAN device and a first WLAN device; and
one or more interfaces configured to:
transmit one or more management frames including a first management frame to the first WLAN device, the first management frame indicating the second WLAN device supports the non-OFDM data rate for communications via the one or more frequency bands; and
receive a second management frame from the first WLAN device, the second management frame indicating the first WLAN device supports the non-OFDM data rate for communications via the one or more frequency bands.

26. The apparatus of claim 25, wherein the non-OFDM data rate is a data rate of a plurality of data rates associated with an IEEE 802.11b standard, and the one or more frequency bands include one or more non-2.4 GHz bands, the one or more non-2.4 GHz bands including one or more of a 3.5 GHz band, a 5 GHz band, a 6 GHz band, a 45 GHz band, and a 60 GHz band.

27. The apparatus of claim 25, wherein the non-OFDM data rate is a data rate of a plurality of non-conformant data rates, and the one or more frequency bands include one or more non-2.4 GHz bands, the one or more non-2.4 GHz bands including one or more of a 3.5 GHz band, a 5 GHz band, a 6 GHz band, a 45 GHz band, and a 60 GHz band.

28. The apparatus of claim 25, wherein:
the one or more interfaces are configured to transmit the first management frame to the first WLAN device via a first BSS associated with the non-OFDM data rate, the first management frame indicating the second WLAN device supports the non-OFDM data rate for communications via the one or more frequency bands; and
the one or more interfaces are configured to transmit a third management frame to the first WLAN device via a second BSS associated with an OFDM data rate, the third management frame indicating the second WLAN device supports an OFDM data rate for communications via the one or more frequency bands.

29. The apparatus of claim 25, wherein:
the one or more interfaces are configured to transmit a first control frame to cause neighboring OFDM WLAN devices of the second WLAN device to stop performing communications;
the one or more interfaces are configured to transmit a second control frame to the first WLAN device, the second control frame to cause neighboring non-OFDM WLAN devices of the second WLAN device to stop performing communications;
the one or more interfaces are configured to receive a third control frame from the first WLAN device in response to transmitting the second control frame, the third control frame to cause neighboring non-OFDM WLAN devices of the first WLAN device to stop performing communications; and
the one or more interfaces are configured to transmit one or more data frames that use the non-OFDM data rate via a selected one of the one or more frequency bands.

30. The apparatus of claim 29, wherein the first control frame is an OFDM CTS-to-Self (CTS2Self) frame, the second control frame is a non-OFDM request to send (RTS) frame, and the third control frame is a non-OFDM clear to send (CTS) frame.
